(19) United States
(12) Patent Application Publication
(10) Pub. No.: US 2008/0183525 A1
(43) Pub. Date: Jul. 31, 2008

(54) BUSINESS MICROSCOPE SYSTEM

(76) Inventors: Satomi TSUJI, Kokubunji (JP); Kazuo Yano, Hino (JP); Norihiko Moriwaki, Hino (JP); Nobuo Sato, Saitama (JP); Minoru Ogushi, Kodaira (JP); Yoshihiro Wakisaka, Kokubunji (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 12/022,630

(22) Filed: Jan. 30, 2008

(30) Foreign Application Priority Data
Jan. 31, 2007 (JP) 2007-021156
Jun. 21, 2007 (JP) 2007-164112

(51) Int. Cl. G06F 9/44

(52) U.S. Cl. 705/7

(57) ABSTRACT

A sensor-net system for digitizing a relationship between persons in an organization includes plural terminals and a processor for processing data received from those terminals. Each of the terminals includes a sensor for sensing a physical amount and a data sender for sending data denoting the physical amount sensed by the sensor. The processor calculates a value denoting a relationship between a first terminal wearing person and a second terminal wearing person according to the data received from the first and second terminals.

### CLAIM OF PRIORITY

The present application claims priority from Japanese application JP 2007-021156 filed on Jan. 31, 2007, and JP 2007-164112 filed on Jun. 21, 2007, the content of which is hereby incorporated by reference into this application.

### FIELD OF THE INVENTION

The present invention disclosed in this specification relates to a technique for visualizing indicators of an organization by acquiring data of face-to-face communications between persons in the organization.

### BACKGROUND OF THE INVENTION

Improvement of productivity is a mandatory issue in every organization and many trials and errors have been repeated to improve the environmental conditions of offices and efficiency of jobs. In the case of such productivity improvement in organizations for assembling and transporting industrial parts and products, the results of achieved improvements can be analyzed and evaluated objectively by tracing the paths of those parts and products moved from the factories. However, in the case of “white-collar” organizations for carrying out such knowledge works as clerical, sales, planning works, etc., it is impossible to evaluate those services and works just by observing things, since those services and works are not related directly to things. Every organization, to begin with, is established to achieve a large scale job or work with combined power of many people when it is beyond one's capacity. In any of such organizations, decision-making and agreements are always made by two or more persons. And such decision-making and agreements are often influenced by a relationship between or among persons and in its turn, the success or failure comes to decide the productivity. The relationship may be that between or among superior authorities, staff members, friends, etc. and furthermore it may include diversified mutual feelings such as favors, a sense of aversion, reliability, or influences. To establish a relationship between persons, in any way, it is indispensable to promote better mutual understandings, that is, mutual communications. This is why the present inventor has come to reach a conclusion that a relationship between persons can be analyzed and evaluated through records acquired from such communications.

A technique for surveying records of such communications between persons in an organization is disclosed in, for example, JP-A No. 2003-085347 and Eagle, N., and Pentland, A., “Reality Mining: Sensing Complex Social Systems”, J. Of Personal and Ubiquitous Computing, July 2005.

JP-A No. 2003-085347 discloses a technique for analyzing communications by relating log information such as utterance data, header information, etc. in a mailing list to a specific event or topic.

Eagle, N., and Pentland, A., “Reality Mining: Sensing Complex Social Systems”, J. Of Personal and Ubiquitous Computing, July 2005 discloses a technique for analyzing communications with use of sending/receiving records of portable phones.

On the other hand, a technique for investigating actions of persons is disclosed in, for example, JP-A No. 2004-046560 and JP-A No. 2005-205167.

JP-A No. 2004-046560 discloses a technique for analyzing actions of a person living in solitude according to the information collected by plural sensors.

JP-A No. 2005-205167 discloses a technique for supplying necessary information of the health care for persons by calculating energy consumption of each person according to the person's activity sensed by a sensor.

### SUMMARY OF THE INVENTION

According to the role theory of Mead, a sociologist of USA, a personal role is what is expected so by others, internalized by the person himself/herself, and approved by both the person himself/herself and others around the person (Mind, Self and Society from the Standpoint of a Social Behaviorist, authored by George Herbert Mead, translated by Inaba, Takizawa, and Nakano, and published by Aoki Bookstore, 1973). In other words, a relationship between persons can be the as a set of roles ruled mutually through communications and the process as a series of events of trials and errors, as well as negotiations. Consequently, the relationship changes each time a communication is made and it includes eventuality and uncertainty. If this is taken into account, it is conceivable that a tactful movement in business in a relationship is made through informal communications such as chatting, etc. and in formal communications such as negotiations and decision making, it is conceivable that such a tactful movement starts as soon as a subject job is completed.

Conventionally, it has been considered that many jobs in each IT-promoted organization are achieved with use of such IT tools as e-mails, portable phones, etc., so that each relationship between persons can be evaluated by analyzing the records of those e-mails, etc. However, upon sending those e-mails and making phone calls, it is required to specify addresses. Thus it can be the in this case that a decided relationship is already established between those persons. In other words, conventional analysis of records of e-mails and portable phones has just been effective partially; it has been no other than cutting out an already existing relationship as a static cross sectional view.

Under such circumstances, it is an object of the present invention to grasp a relationship between persons as a dynamic process. And in order to materialize this, it is indispensable to acquire face-to-face communication data. Because, a human being consists of physical parts and he/she often makes various physical expressions during such communications consciously and even unconsciously. Such a physical expression is an expression of a personal inner world. In addition, such physical expressions cause mutual entrainments by exchanging nodding, gestures, eye-contacts, etc. as a process of trials and errors for establishing the relationship, thereby generating a common rhythm between them. The face-to-face contacts can use such physical expressions freely, so that they are very effective upon decision making that requires negotiations, sympathy, and mutual concessions. Consequently, acquirement and analysis of communications are indispensable for the essential items to determine the productivity of an organization.

As for the face-to-face communication data described above, what is needed is at first is information that denotes “who” has faced “whom” and “when”. Furthermore, it is also needed to know “how” the communication was made. At this time, in order to grasp a process of physical expressions as described above, it is required to acquire timely continuous data (or to acquire data at short intervals when not continued).

Furthermore, a mechanism for acquiring a mass of data (related to many persons) continuously is also required so as to utilize such face-to-face communication data in the subject organization for improving the productivity. Decision making is often affected by a relationship having been fostered between or among subject persons for a long time. The relationship is adjusted even during a communication according to the communication itself. This is why it is impossible to analyze a relationship process without acquiring the data continuously (or acquiring the data at short intervals). And because the face-to-face communication is not decoded yet, the meaning and merit of the data cannot be extracted without comparing and processing such a mass of data.

Each of JP-A No. 2003-085347 and Eagle, N., and Pentland, A., “Reality Mining: Sensing Complex Social Systems”, J. Of Personal and Ubiquitous Computing, July 2005 discloses a technique for analyzing communications by e-mail or by portable phone. However, any of those documents does not disclose any technique for analyzing face-to-face communications between persons. Consequently, the technique cannot analyze any relationship between persons according to the face-to-face communications.

Each of JP-A No. 2004-046560 and JP-A No. 2005-205167 discloses a technique for collecting and analyzing data denoting physical activities of persons. According to those documents, however, the collected data do not denote any communications between persons. Consequently, the technique cannot analyze any relationship between persons.

Under such circumstances, it is an object of the present invention to acquire information usable as indicators denoting improvement of an organization, satisfaction of the customers, satisfaction of the employees, etc. by analyzing the face-to-face communications between persons. Concretely, analysis is made for dynamic and diversified relationships between persons by acquiring a mass of dynamics data of a subject organization including information denoting “who and who have made a subject communication and how and when” continuously and according to the acquired information.

One of the typical objects of the present invention to be disclosed in this specification is a sensor network system comprising plural terminals and a processor for processing data received from those terminals. Each of the terminals includes a sensor for sensing a physical amount and a data sending unit for sending the physical amount sensed by the sensor. The processor calculates a value for denoting a relationship between a first person wearing a first one of the terminals and a second person wearing a second one of the terminals according to the data received from the first and second terminals.

According to an embodiment of the present invention, it is possible to extract dynamic and diversified relationships between persons according to their face-to-face communications.

### BRIEF DESCRIPTION OF THE DRAWINGS

FIG. 1 is a diagram for describing a flow of the processings executed in a first embodiment of the present invention;

FIG. 2 is a block diagram of an overall configuration of a sensor-net system for realizing a business microscope system in the first embodiment of the present invention;

FIG. 3 is a sequence chart for describing a procedure for displaying a relationship between persons in an organization according to the data acquired by a terminal in the first embodiment of the present invention;

FIG. 4 is a sequence chart for describing procedures of association and time synchronization in the first embodiment of the present invention;

FIG. 5A is a diagram for describing an infrared data format used to send infrared data by radio in the first embodiment of the present invention;

FIG. 5B is a diagram for describing an acceleration data format used to send acceleration data by radio in the first embodiment of the present invention;

FIG. 5C is a diagram for describing a voice data format used to send voice data by radio in the first embodiment of the present invention;

FIG. 6 is a diagram for describing a concrete example for describing a sensing database in the first embodiment of the present invention;

FIG. 7 is a diagram for describing an example of a connected table in the first embodiment of the present invention;

FIG. 8 is a diagram for describing an example of organization activity analysis and organization activity representation in the first embodiment of the present invention;

FIG. 9 is a diagram for describing examples of organization activity analysis and organization activity representation in a second embodiment of the present invention;

FIG. 10 is another diagram for describing examples of organization activity analysis and organization activity representation in the second embodiment of the present invention;

FIG. 11 is a diagram for showing a flow of the processings executed in a third embodiment of the present invention;

FIG. 12 is a sequence chart for showing a usage scene in the third embodiment of the present invention;

FIG. 13 is a sequence chart for showing a procedure of feedback processings in the third embodiment of the present invention;

FIG. 14 is an example of a feedback mail in the third embodiment of the present invention;

FIG. 15 is an example of a feedback image in a fourth embodiment of the present invention;

FIG. 16 is an example of a performance questionnaire in the fourth embodiment of the present invention;

FIG. 17 is an example of a performance questionnaire in the fourth embodiment;

FIG. 18 is an example of a feedback image in the fourth embodiment of the present invention; and

FIG. 19 is an example of a feedback image in the fourth embodiment of the present invention.

### DETAILED DESCRIPTION OF THE PREFERRED EMBODIMENTS

Hereunder, there will be described the preferred embodiments of the present invention with reference to the accompanying drawings.

In those embodiments of the present invention, it is premised that a compact terminal (e.g., ID card type terminal) is worn by each person in a subject organization and used to obtain data related to the organization dynamics. This terminal may be shaped freely if the person wearing this terminal can fulfill his/her daily jobs and actions with no problems. For example, the terminal may take any shape of an ID card type, wrist watch, finger ring, wrist band, etc. The terminal may be put in a pocket of the clothe or clasped on the cloth or shoe. The terminal may also be built in a business tool or any of other tools. And it may be attached to a pen, the cap of the pen, etc.

The terminal senses the situation of the person wearing the terminal through a sensor, etc. built therein. Furthermore, the terminal acquires the data related to the person's actions, as well as voices heard around the person periodically. The acquired data is sent to a gateway by radio, then collected in a server on the subject network. Upon analyzing the data, the data is fetched from the server with reference to the terminal unique identification number (terminal ID) and the data acquired time information. After this a comparison/collation is made among the data acquired by the plurality of terminals in order of the time series. Each of the terminals executes clock synchronization periodically so as to synchronize its time among all of the terminals. The sensing date related to the face-to-face contacts, actions, voices, etc. of the persons in the subject organization are referred to generically as organization dynamics data.

In the preferred embodiments of the present invention, a system is realized so as to execute a series of acquiring, collecting, and analyzing such organization dynamics data. This system will be referred to as a “business microscope”.

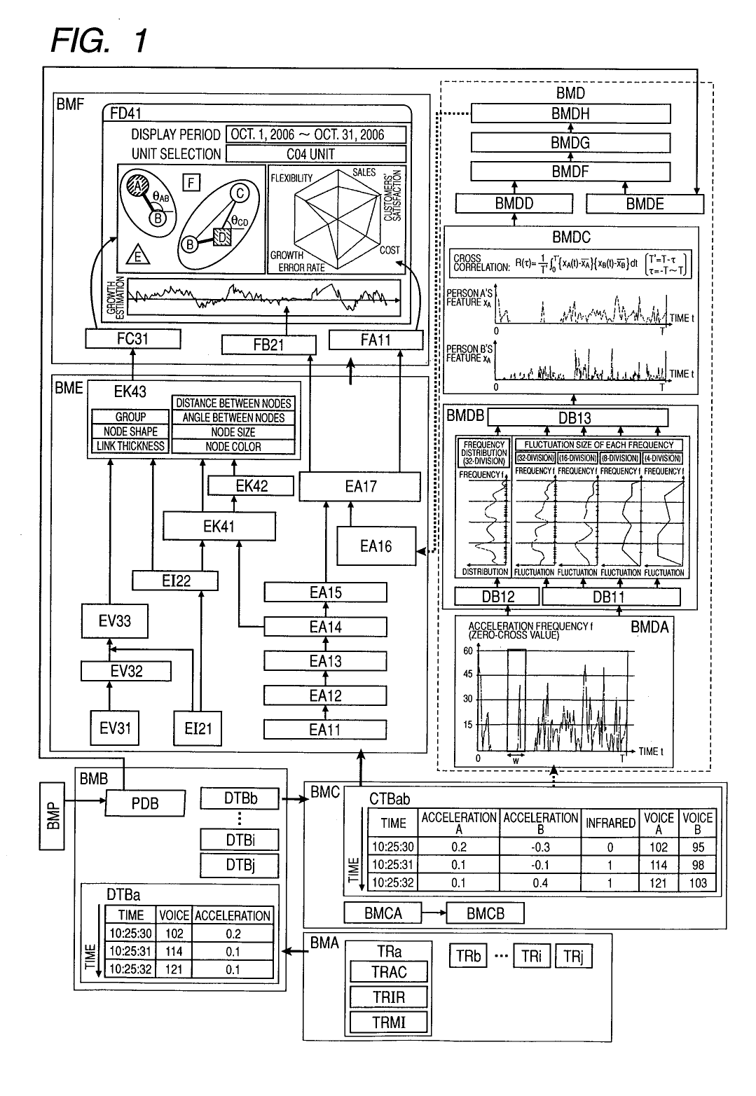

FIG. 1 is a diagram for describing an overall flow of the processings executed in a first embodiment of the present invention.

Concretely, FIG. 1 shows a flow of the series of processings from organization dynamics data obtainment by plural terminals to illustration of each relationship between organization members and the current organization assessment (performance) as the organization activity.

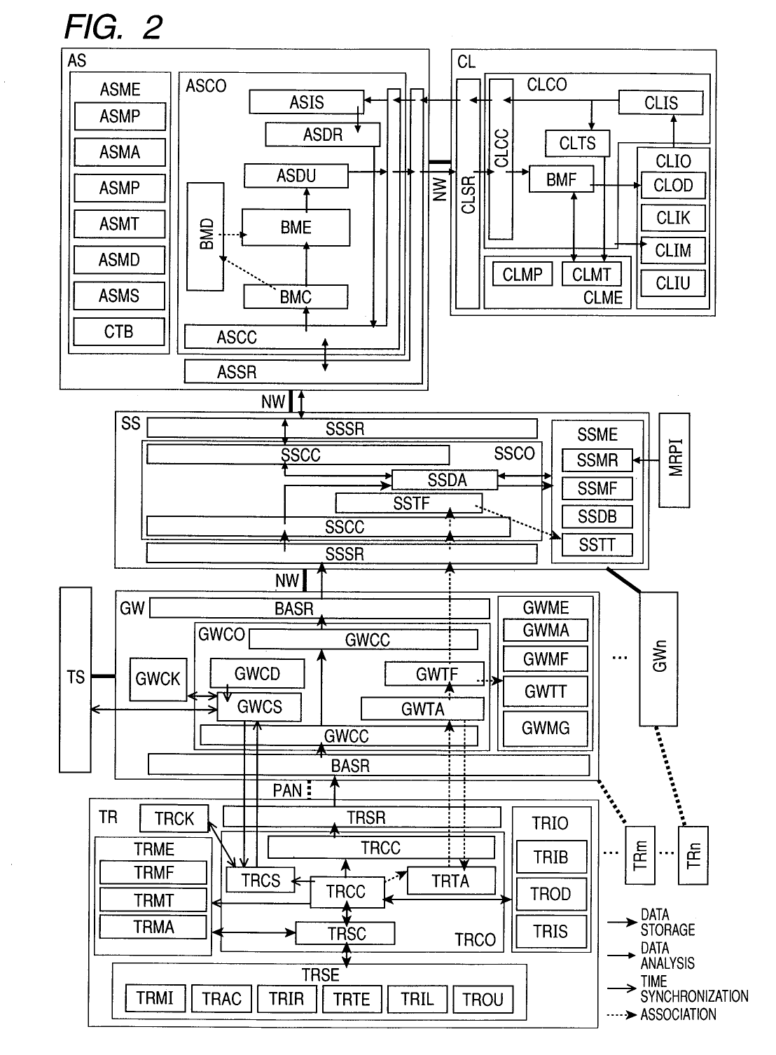

In this first embodiment, the following processings are executed in a proper order; organization dynamics data obtainment (BMA), performance input (BMP), organization dynamics data collection (BMB), data alignment (BMC), correlation coefficient learning (BMD), organizational activity analysis (BME), and organizational activity presentation (BMF). The overall system configuration including units, devices, etc. required for executing those processings will be described later with reference to FIG. 2.

At first, there will be described the processing of organization dynamics data obtainment (BMA). A terminal A (TRa) includes sensors such as an acceleration sensor (TRAC), an infrared sender/receiver (TRIR), a microphone (TRMI), etc., as well as a microcomputer (not shown) and radio sending functions. The sensors are used to sense various types of physical amounts and obtain data denoting those sensed physical amounts. For example, the acceleration sensor (TRAC) senses the acceleration of the terminal A (TRa), that is, the acceleration of the person A (not shown) wearing the terminal A (TRa). The infrared sender/receiver (TRIR) senses a face-to-face contact state of the terminal A (TRa) (a state in which the terminal A is facing another terminal). The state in which the terminal A (TRa) is facing another terminal means that person A wearing the terminal A (TRa) is facing another person wearing another terminal. The microphone (TRMI) senses voices around the terminal A (TRa). The terminal A (TRa) may also include other sensors (e.g., temperature sensors, illuminance sensors, etc.).

The system in this first embodiment includes plural terminals (the terminal A (TRa) shown in FIG. 1 to the terminal J (TRj)). Each of the terminals is worn by a person. For example, the terminal A (TRa) is worn by the person A and the terminal B (TRb) is worn by the person B (not shown). This is because a relationship between persons is analyzed and furthermore the organization performance is illustrated.

Similarly to the terminal A (TRa), each of the terminals B (TRb) to J (TRj) also includes such sensors, as well as a microcomputer and radio sending functions. In the following descriptions, any of the terminals A (Tra) to J (Trj) may be referred to simply as the terminal (TR) when a description is identical among those terminals and when any of those terminals is not required to be distinguished from others.

Each terminal (TR) keeps sensing (or makes intermittent sensing at short intervals) through sensors. Then, each terminal (TR) sends obtained data (sensing data) to a gateway by radio at predetermined intervals. The data sending interval may be the same as the sensing interval or longer than the sensing interval. The data to be sent at that time includes a sensing time and a unique ID of the terminal (TR) that made sensing. Sending data by radio collectively is to suppress the power consumption during the data sending, thereby keeping the usable state of the terminal (TR) as long as possible while the terminal (TR) is worn by the person. And the same sensing interval should preferably be set among all the terminals (TR) for the conveniences of the analysis to be executed later.

The performance input (BMP) is a processing for inputting performance values. The performance means a subjective or objective evaluation to be decided according to a reference. For example, a person wearing a terminal (TR) inputs a value of an objective evaluation (performance) at a predetermined timing according to a reference such as a job's achievement level, a level of contribution to the organization, and a satisfaction level, etc. with respect to the subject organization at that point of time. The predetermined timing may be, for example, once in several hours, once on a day, or a point of time at which such an event as a meeting or the like is ended. The terminal (TR) wearing person can input such performance values by operating the terminal (TR) or a PC (Personal Computer) like a client (CL). Hand-written values may also be inputted to the PC later collectively. Inputted performance values are used to learn correlation coefficients. Consequently, it is required here to input performance values just enough to make object learning to some degree; there is no need to input so many values.

Organization related performance values may also be calculated from personal performances. Objective data such as a sales account, cost, or the like, as well as already existing numerical data such as customers' questionnaire results, etc. may be inputted periodically as performance values. If there are any numerical data such as an error rate in production management, etc. that are obtained automatically, those obtained numerical data may be inputted as performance values.

Data sent from each terminal (TR) by radio are collected in the process of organization dynamics data collection (BMB), then stored in a database. For example, a data table is created for each terminal (TR), that is, for each person wearing the terminal (TR). Collected data are classified according to unique identification data and stored in data tables respectively in order of the sensing time series. If a table is not created for each terminal (TR), a column for denoting each terminal identification data or person is required in a data table. The data table A (DTBa) shown in FIG. 1 represents a simplified example of such a data table.

Performance values inputted in the process of performance input (BMP) are stored together with their time information in a performance database (PDB).

In the process of data alignment (BMC), two persons related data are aligned (data alignment) (BMCB) according to their time information to make a comparison between those two persons (between data obtained by the terminals (TR) worn by those persons) (BMCA). The aligned data are stored in a table. At this time, among the data related to those two persons, the data having the same time are stored in one record (line). The data having the same time are two data including a physical amount sensed by two terminals (TR) at the same time. If the data related to tow persons do not include any data having the same time, the data having the closest times may be used approximately as the data having the same time. In this case, the data having the closest times are stored in one record. At this time, the times of the data stored in one record should preferably be aligned with use of the average value of the closest times. Those data are just required to be stored so that a comparison can be made between the data according to the time series; they may not be stored necessarily in a table.

The connected table shown in FIG. 1 is a simplified example of a table formed by combining a data tables A (DTBa) and B (DTBb). The details of the data table B (DTBb) are omitted here. A connected table (CTBab) includes data of acceleration, infrared, and voice. Such a connected table may also be created for each type data, for example, a connected table including only acceleration data or a connected table including only voice data.

In this first embodiment, the process of correlation coefficient learning (BMD) is executed to calculate a relationship and estimate performance from organization dynamics data. To execute this process, at first, a correlation coefficient is calculated with use of data in a certain period in the past. This process will be more effective if the correlation coefficient is updated with periodical recalculation by using new data.

Hereunder, there will be described an example for calculating a correlation coefficient from acceleration data. However, instead of such acceleration data, time series data such as voice data, etc. may be used to calculate a correlation coefficient similarly.

In this first embodiment, an application server (AS) (shown in FIG. 2) executes the process of correlation coefficient learning (BMD). Actually, however, the correlation coefficient learning (BMD) may be executed by any apparatus other than the application server (AS).

At first, the application server (AS) sets a period ranged from a few days to a few weeks as a data width T used for calculating a correlation coefficient, then select the data in the period.

Then, the application server (AS) executes the process of acceleration frequency calculation (BMDA). The process of acceleration frequency calculation (BMDA) is executed to obtain a frequency from acceleration data arranged in order of the time series. The frequency is defined as a frequency of vibration of a wave for one second. In other words, the frequency is an indicator for representing the intensity of vibration. However, Fourier transformation is required to calculate such a frequency correctly, so that this will become a burden on the calculation amount. While it is possible to calculate a frequency through Fourier transformation steadily, zero-cross data is employed instead of the frequency to simplify the calculation in this first embodiment.

The zero-cross data means the number of times the time series data in a certain period becomes zero. More precisely, the zero-cross data means a count denoting the number of times the time series data is changed from positive to negative or from negative to positive. For example, if one cycle is defined as a period in which an acceleration value changes from positive to negative, then the value changes from positive to negative again, it is possible to calculate the number of vibrations per second from the zero-cross count. The number of vibrations counted for one second in such a way can be used as a frequency approximated to an acceleration value. Such zero-cross data can be counted from, for example, the number of pairs, each pair consisting two consecutive sensing points of time, one at which an acceleration value is sensed by a sensor and the other at which another acceleration value is sensed by the sensor and those sensed acceleration values are reversed in positive and negative state between those two consecutive sensing points of time.

Furthermore, the terminal (TR) in this first embodiment includes acceleration sensors in the directions of the three axes, so that the zero-cross data in the directions of those three axes are totaled in the same period, thereby calculating one zero-cross data item. Consequently, the zero-cross data can be used as an indicator for representing the intensity of vibrations of sensed fine swings of a pendulum, particularly in a right-left direction and in a front-rear direction.

As “a certain period” for calculating zero-cross data, a value larger than the consecutive data interval (the original sensing interval) is set in seconds or minutes.

Furthermore, the application server (AS) sets a window width w that is a time interval larger than the zero-cross data and smaller than the total data width T. In the next step, the application server (AS) obtains both distribution and fluctuation of a frequency in this window. Then, the application server (AS) moves the window along the time axis step by step to calculate the distribution and fluctuation of the frequency for each window.

If a window is moved by the same width as the window width w at this time, duplication of data between windows is prevented. As a result, a feature graph used in the process of cross-correlation calculation (BMDC) becomes a discrete graph. On the other hand, if a window is moved by a width smaller than the window width w, part of data in each window is duplicated with others. As a result, the feature graph to be used later in the process of cross-correlation calculation (BMDC) becomes a continuous graph. A width for moving a window may be set freely by taking those items to consideration.

In FIG. 1, zero-cross data is also represented as a frequency. In the following descriptions, the “frequency” means a concept that includes zero-cross data. In other words, as the “frequency” to be mentioned below, it is possible to use an accurate frequency calculated through Fourier transformation or an approximate frequency calculated from zero-cross data.

After this, the application server (AS) executes the process of personal feature extraction (BMDB). The process of personal feature extraction (BMDB) is a processing for calculating both frequency distribution and frequency fluctuation of acceleration in each window, thereby extracting a personal feature.

At first, the application server (AS) finds frequency distribution (intensity) (DB12).

In this first embodiment, the frequency distribution means frequency of acceleration occurrence at each frequency.

Acceleration frequency distribution is affected by the time consumed by an action of a terminal (TR) wearing person. For example, the acceleration frequency differs between when the person is walking and when the person is typing a mail at a PC. And in order to record such an acceleration history histogram, acceleration occurrence frequency is obtained at each frequency.

At this time, the application server (AS) decides the maximum frequency to be estimated (required). The application server (AS) then divides the frequency value into 32 values between 0 and the maximum value. After this, the application server (AS) counts the number of acceleration data included in each divided frequency range. The acceleration occurrence frequency at each frequency counted in such a way is handled as a feature. The similar processings are executed for each window.

In addition to the acceleration frequency distribution, the application server (AS) also calculates the “a fluctuation at each frequency” (DB11). A frequency fluctuation means a value denoting how long an acceleration frequency is kept consecutively.

Each frequency fluctuation is an indicator denoting how many hours a person's action is continued. For example, for a person who has walked 30 minutes in one hour, the meaning of his/her action differs between when the person walks for one minute, then stops for one minute and when the person keeps walking for 30 minutes, then takes a rest for 30 minutes. These actions can be classified by calculating each frequency fluctuation.

However, a fluctuation level comes to differ significantly according to a set criterion for a range in which the difference between continued two values is allowed to decide that the continuity of those values is still kept. In addition, there might occur missing of information representing the dynamics of data of whether a frequency value has made a change slightly or significantly. In this first embodiment, therefore, the full range of acceleration frequencies is divided into the predetermined number of sections. The full range of frequencies mentioned here means a range between frequency [0] to the maximum value (see step DB12). A divided section is used as a reference for deciding whether or not a value is kept. For example, the number of divisions is 32, the full range of frequencies is divided into 32 sections.

For example, an acceleration frequency at a time t is in the i-th section and the acceleration frequency at the next time t+1 is in any of the (i+1)-th section, the i-th section, and the (ii+1)-th section, it is decided that the acceleration frequency value is kept. On the other hand, if the acceleration frequency at a time t+1 is not in any of the (ii−1)-th, the i-th, and the (ii+1)-th sections, it is decided that the acceleration frequency value is not kept. And the number of times the frequency value is decided to be kept is counted as a feature denoting the fluctuation. The above processings are executed for each window.

Similarly, a fluctuation feature is calculated for each of the number of divisions that are 16, 8, and 4. In such a way, if the number of divisions is varied for calculating a fluctuation at each frequency, the fluctuation feature will be able to represent any of small and large fluctuations.

If the full range of the frequencies is divided into 32 sections and the transition from the section i of a frequency to any section j is to be traced, it is required to take 1024 transition patterns that is the square of 32 into consideration. As a result, a problem arises; when there are many patterns, the number of calculations also increases. In addition, the data that can apply to one pattern decreases, so that the statistical error comes to increase.

On the other hand, when a feature is to be calculated for each of the number of divisions that are 32, 16, 8, and 4 as described above, it is just required to take consideration to 60 patterns. Thus the statistical reliability is improved. Furthermore, as described above, a feature is calculated for each of some divisions between large and small division numbers. As a result, diversified transition patterns can be reflected in features.

The above description is for an example of calculating both distribution and fluctuation of acceleration frequencies. However, the application server (AS) can also apply the same processings as those described above to the obtained data other than the acceleration one (e.g., voice data). Thus the application server (AS) comes to calculate each feature according to the obtained data type.

The application server (AS) handles 92 values that are a total of 32 patterns of frequency distribution calculated as described above and 60 patterns of the frequency fluctuation sizes as features of a subject person in the time band of each window (DB13). Those 92 features (x_{A1} to x_{A92}) are all independent respectively.

The application server (AS) calculates each of the features as described above according to the data received from the terminal (TR) of every member belonging to a subject organization (or every member to be analyzed). Features are calculated for each window, so that the features are plotted in order of the time series of the windows, thereby each member's features can be handled as time series data. The time of a window can be decided freely on any rules. For example, the time of a window may be a center time or the starting time of the window.

The features (x_{A1} to x_{A92}) described above are of the person A calculated according to the acceleration data sensed by the terminal (TR) worn by the person A. Similarly, the features (e.g., x_{B1} to x_{B92}) are calculated for another person (e.g., person B) according to the acceleration data sensed by the terminal (TR) worn by the person (e.g., the person B).

After that, the application server (AS) executes the process of cross-correlation calculation (BMDC). The process of cross-correlation calculation (BMDC) finds cross-correlation between the features of two persons. The two persons are assumed here as persons A and B.

The time series change of the feature of the person A is shown as a feature x_{A} graph in the process of cross-correlation calculation (BMDC) shown in FIG. 1. Similarly, the graph of the feature x_{B} of the person B is shown in the process of cross-correlation calculation (BMDC).

At this time, the feature (e.g., x_{A1}) of the person A influences on the feature (e.g., x_{B1}) of the person B and the influence is represented by a function of the time τ as follows.

$$R ( τ ) = \frac{1}{T} \cdot \frac{{\int }_{0}^{{r}^{′}} \{ {x}_{A} ( t ) - \overline{{x}_{A}} \} \{ {x}_{B} ( t ) - \overline{{x}_{B}} \} d t}{\sqrt{{\int }_{0}^{{r}^{′}} {\{ {x}_{A} ( t ) - \overline{{x}_{A}} \}}^{2} d t} \sqrt{{\int }_{0}^{{r}^{′}} {\{ {x}_{B} ( t ) - \overline{{x}_{B}} \}}^{2} d t}} \\ ( \begin{matrix}{T}^{′} = T - τ \\ τ = T - T\end{matrix} ) \qquad ( 1 )$$

x_{A1}(t): Value of the feature x₁ of the person A at the time t x̅_̅{̅A̅1̅}̅: Average value of the feature x₁ of the person A within a period of 0 to T

The same calculation can also apply to the person B. The T denotes a time width during which there is frequency data.

In other words, in the above equation, if R(τ) reaches its peak at τ=τ₁, the action of the person B at a time has a tendency similar to that of the person A preceding by τ₁ from the time. This is because the feature x_{B1} of the person B is affected by the feature x_{A1} of the person A the time τ₁ after the person A begins his/her action.

The τ value at which this peak appears can be interpreted to represent an influence type. For example, if the τ value denotes a few seconds or under, it is regarded to represent an influence such as nodding, etc., that is, a direct meeting. If the τ value denotes a time ranged from a few minutes to a few hours, it is regarded to represent an influence of an action.

The application server (AS) executes the process of this cross-correlation calculation for 92 patterns, which is the total number of features with respect to the persons A and B. Furthermore, the application server (AS) calculates features in the above procedure for each combination between members belonging to the subject organization (or all the object members to be analyzed).

The application server (AS) then obtains plural features with respect to the subject organization from the results of the cross-correlation calculation for the features found above. For example, the application server (AS) divides a time range into some sub-time ranges such as within one hour, within one day, within one week, etc. and handles the value of each pair of persons as an organization feature (BMDD). The method employed here to decide a constant as a feature from a result of the cross-correlation calculation may not be limited only to the one described above. Consequently, one organization feature comes to be obtained from one cross-correlation equation. If there are 92 personal features, 8464 organization features that are the square of 92 can be obtained for each pair of persons. Cross-correlation is affected by the influence and relationship of each pair of members belonging to the subject organization. Consequently, using the values obtained through such cross-correlation calculations will make it possible to handle an organization composed of relationships between persons quantitatively.

On the other hand, the application server (AS) obtains the data of quantitative evaluation (hereinafter, to be described as performance) from a performance database (PDB) (BMDE). As to be described later, the application server (AS) calculates the correlation between the above organization feature and the performance. The performance may be calculated from, for example, a personal achievement level reported by each person or a subjective evaluation result with respect to a human relationship of the organization, etc. The financial evaluation of an organization, such as sales, loss, etc. may also be used as the performance. The performance is obtained from the performance database (PDB) used for the process of organization dynamics data collection (BMB) and handled as the performance evaluated time information. In this embodiment, there will be described an example of organization performance, in which 6 indicators (p₁, p₂, . . . , p₆) are used as organization performance parameters. The 6 indicators are sales, customer's satisfaction, cost, error rate, growth, and flexibility.

Then, the application server (AS) makes an analysis for the correlation between an organization feature and each organization performance (BMDF). Actually, however, there are many organization features and unnecessary features are included among them. Consequently, the application server (AS) selects only effective features with use of the stepwise method (BMDG). At this time, the application server (AS) may also select necessary features with use of another method other than the stepwise method.

The application server (AS) then decides a correlation coefficient A1 (a₁, a₂, . . . , aₘ) that satisfy the equation (2) in the relationship between each of selected organization features (X₁, X₂, . . . , Xₘ) and each organization performance (BMDH).

p₁=a₁X₁+a₂X₂+ . . . +aₘXₘ (2)

In the example shown in FIG. 1, m is 92. This calculation is made for p₁ to p₆ to decide A₁ to A₆ for each of p₁ to p₆. In this case, the simplest linear modeling is employed. However, it is also possible to use the X₁, X₂ values, etc. with use of a non-linear model so as to improve the modeling accuracy more. And it is also possible to use the means of the neutral network approach, etc. to improve the modeling accuracy more.

The application server (AS) then makes 6 performance estimations from acceleration data by using those correlation coefficients of A₁ to A₆.

The process of organization activity analysis (BME) finds a relationship between persons and calculates organization performance from such data as acceleration, voice, face-to-face contact data, etc. with respect to any two persons in the connected table.

As a result, the application server (AS) can present each organization performance estimation in real time to the user while obtaining necessary data, thereby prompting the user to change his/her actions to lead better results if a bad estimation is made. Thus, the application server (AS) can feed back data in short cycles.

At first, there will be described a calculation to be made with use of acceleration data (EA11). The processes of acceleration frequency calculation (EA12), personal feature extraction (EA13), calculation of the cross-correlation between persons (EA14), and organization feature calculation (EA15) are similar to those of correlation coefficient learning (BMD), acceleration frequency calculation (BMDA), personal feature extraction (BMDB), and organization feature calculation (BMDD). The description for those processes will be omitted here. Those processes are executed to calculate organization features (x₁, . . . , xₘ).

Then, the application server (AS) obtains the correlation coefficients (A₁, . . . A₆) with respect to the organization features (x₁, . . . , xₘ) calculated in step EA15 and each performance calculated in the process of correlation coefficient learning (BMD) (EA16), then calculates the indicator value of each performance with use of those coefficients.

p₁=a₁x₁+a₂x₂+ . . . +aₘxₘ (3)

This value is assumed as an estimation value of the organization performance (EA17).

As to be described later, the latest values of the 6 indicators denoting the organization performance are displayed in a balance graph. Furthermore, the history of an indicator value is displayed as a time series graph of the indicator estimation history.

The distance between any persons (EK41) obtained from the cross-correlation value between persons is used to decide a parameter (organization structure parameter) for displaying an organization structure. The distance between persons mentioned here is not a geographical distance, but an indicator denoting a relationship between persons. For example, the stronger the relationship between persons is (e.g., the cross-correlation between persons is strong), the shorter the distance between the persons becomes. And a group of persons is decided by executing the process of grouping (EK42) according to the distance between persons.

Grouping mentioned above means a processing for creating a group for persons who are closely related to each another so that at least two persons A and B who are particularly closely related to each other is set in a group and at least other two persons C and D who are closely related to each other are set in another group, and then those persons A to D are set in a larger group. If such a group is reflected in its representation, persons who are closely related to each other can be highlighted in the display so as to distinguish them from others. Furthermore, upon representing or analyzing a larger organization, a pseudo group can also be handled as one person so as to simplify the calculation and make it easier to recognize the overall structure of an object organization.

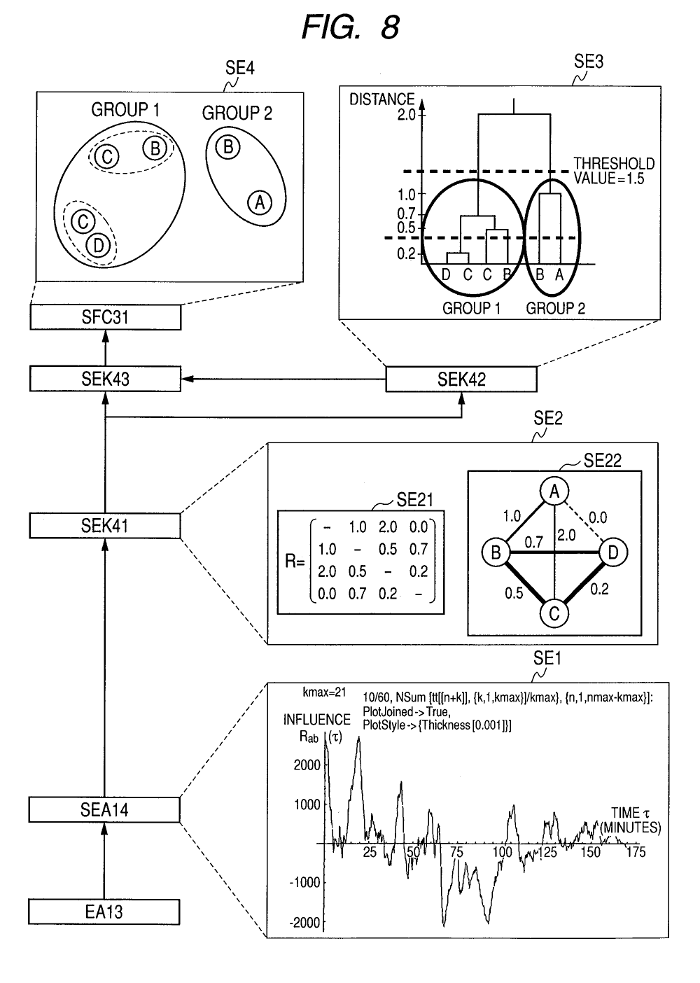

An example for finding a relationship distance between any persons (EK41) in the process of calculation of cross-correlation between persons (EA14) and displaying the distance will be described later (see FIG. 8).

Next, there will be described a calculation to be made according to infrared data (EI21). The infrared data includes information denoting when and who have faced each other. The application server (AS) analyses the face-to-face contact record with use of such infrared data (EI22). The application server (AS) then decides a parameter for displaying an object organization structure according to the face-to-face contact record (EK43). At this time, the application server (AS) may calculate a distance between any persons from the face-to-face contact record to decide the parameter according to the distance. For example, the application server (AS) calculates such a relationship distance so that the more frequently the two persons have faced in a predetermined period, the shorter the distance between those persons becomes (this means that the relationship between those persons is strong).

For example, the application server (AS) may decide the parameter so that the total number of face-to-face contact times with respect to one person is reflected in the size of a node, the face-to-face contact frequency between those persons in a short period is reflected in the distance between nodes, and the face-to-face contact frequency between any persons in a long period is reflected in the thickness of the link. The node mentioned here is a figure displayed to denote each person on a display (CLOD) of a client (CL). A link means a line displayed so as to connect two nodes to each other. As a result, so far a person who has faced more persons regardless of who are they is displayed with a larger node. A combination of persons who have faced more frequently recently is displayed with two adjacent nodes. A combination of persons who have faced more frequently for a long period is displayed with two nodes connected by a thicker link.

Furthermore, the application server (AS) can reflect the attribution of each user wearing a terminal in the display of the subject organization structure. For example, the color of a node denoting a person may be decided by the age of the person or the shape of the node may be decided by his/her post in the organization.

Next, there will be described how to make a calculation according to voice data (EV31). As described above, voice data can be used instead of acceleration data to calculate cross-correlation between persons just like in the case using acceleration data. In this case, it is also possible to extract a conversational feature (EV32) by extracting a voice feature from subject voice data (EV32) and analyzing the feature together with the face-to-face contact data (EV33). A conversational feature means a level of a voice tone, conversation rhythm, or conversational balance in the subject conversation. Conversational balance means a level denoting whether only one of two persons speaks to the other or the two persons speak to each other equally. The conversational balance is extracted according to the voices of those two persons.

For example, the application server (AS) may decide the display parameter so that the conversational balance is reflected in the angle between the nodes. Concretely, for example, when two persons makes a conversation equally, the nodes of those two persons may be displayed horizontally. If only one of the two persons speaks to the other, the node of the person who is speaking may be displayed higher than the node of the other person. The more only one person speaks to the other, the angle between a line for connecting the nodes of the two persons and a reference line (θ_{AB} or θ_{CD} in the example of the organization structure display (FC31) shown in FIG. 1) may be displayed larger. The reference line mentioned above means a line set for the traverse (horizontal) direction on a screen. The reference line may not be displayed on the screen.

The process of organization activity display (BMF) creates the processes of index balance indication (FA11), index forecast record (FB21), representation of organization structure (FC31), etc. according to the parameters of organization performance estimation and organization structure calculated in the processings described above and displays those on a screen such as the screen (CLOD) of the client (CL).

The organization activity (FD41) shown in FIG. 1 is an example of a screen displayed on the display (CLOD) of the client (CL).

In the example shown in FIG. 1, at first, a selected display period, a unit to be displayed, and plural members are displayed. The unit mentioned here means an existing organization unit consisting of plural persons. All the members belonging to one unit may be displayed or some of the members of the unit may be displayed. In the example shown in FIG. 1, three types of diagrams are displayed. Those diagrams represent results of analysis on the conditions shown for the display period, the unit, etc. described above.

In the diagram for the process of index forecast record (FB21), the record of a “growth” performance estimation result is shown as an example. Consequently, it becomes possible to analyze what action of a member will contribute to the growth of the organization; furthermore, what is effective to change the negative situation to the positive situation with reference to the action records in the past.

In the process of representation of organization structure (FC31), the application server (AS) visualizes the situation of each small group of the organization, the actual role of each person in the organization, and the balance between given persons, etc.

The process of index balance indication (FA11) denotes the balance in the estimation of the 6 set organization performances. Consequently, the merits and demerits of the organization at present can be confirmed.

FIG. 2 shows a block diagram of an overall configuration of a sensor-net system for realizing a business microscope system in the first embodiment of the present invention.

The business microscope system in this first embodiment, as shown in FIG. 2, is realized by a sensor-net system that includes plural terminals (TR) provided with a sensor respectively and a computer for processing data obtained from those terminals (TR).

More in detail, FIG. 2 shows an overall system configuration and a data flow from how a relationship between persons and an evaluation of the present organization (performance) are calculated as an organization activity from organization dynamics data obtained by terminals (TR) to how the calculated organization activity is displayed.

The four types of arrows shown in FIG. 2 denote data flows in the processes of clock synchronization, association, sensing data storage, and data analysis respectively.

Each of the terminals (TR) is a compact sensor terminal. The terminal (TR) is worn by each of the plurality of sensing object persons. The terminal includes an infrared sender/receiver (TRIR). Although the infrared sender/receiver (TRIR) shown in FIG. 2 includes an infrared sender and an infrared receiver that are united into one, the terminal (TR) may have the infrared sender and the infrared receiver separately.

While the infrared sender/receiver (TRIR) sends/receives infrared signals to/from nodes, thereby sensing whether or not a terminal (TR) has faced another (TR), that is, whether or not a terminal (TR) wearing person has faced another terminal (TR) wearing person. In order to make such signal exchanges sure, each terminal (TR) should therefore be worn in front. For example, an ID card type terminal (TR) may be employed and hung on the person's neck. As to be described later, the terminal (TR) further includes sensors such as an acceleration sensor (TRAC), etc. The sensing process in the terminal (TR) is equivalent to the process of organization dynamics data acquisition (BMA) shown in FIG. 1.

Another radio signal other than the infrared one may be exchanged between terminals (TR) to decide whether or not a face-to-face contact has been made. In this case, the terminals (TR) come to include a sender/receiver for another type radio signal other than the infrared radio signal.

In many cases, there are plural terminals (TR) disposed around and connected to a gateway (GW) to form a personal area network (PAN).

Each terminal (TR) includes a sensing unit (TRSE), an input/output unit (TRIO), a recording unit (TRME), a watch (TRCK), a control unit (TRCO), and a sender/receiver unit (TRSR). Data including information sensed by the sensing unit (TRSE) are sent to the gateway (GW) through the sender/receiver unit (TRSR).

The sensing unit (TRSE) senses a physical quantity. A physical quantity is, for example, of infrared, acceleration, voice, temperature, or illuminance. The sensing unit (TRSE) includes such sensors as a microphone (TRMI), an acceleration sensor (TRAC), an infrared sender/receiver (TRIR), a temperature sensor (TRTE), and an illuminance sensor (TRIL). Furthermore, the sensing unit (TRSE) can also have other additional sensors by connecting them to its external input.

The infrared sender/receiver (TRIR) sends terminal identification data (TRMT) that is unique identification information of the subject terminal (TR) periodically toward the front side. If another terminal (TRm) wearing person is positioned approximately in front (e.g., in front or in obliquely front), the terminal (TR) and another terminal (TRm) exchanges mutual terminal identification data (TRMT) with infrared signals. Consequently, it is possible to record who and who are facing each other.

The acceleration sensor (TRAC) senses acceleration of a node, that is, a motion of the node. It is thus possible to analyze the intensity of each terminal wearing person with respect to such actions as walking, etc. from the acceleration data. Furthermore, if a comparison is made among acceleration values sensed by plural terminals, it comes to be possible to analyze data of the activity level, mutual rhythms, and cross-correlation, etc. between those terminal wearing persons.

The microphone (TRMI) obtains voice information. According to the voice information obtained by the microphone, it is possible to know the environmental conditions such as “noisy”, “quiet”, etc. around the object person. Furthermore, by obtaining/analyzing such voice data of a person, it also comes to be possible to analyze face-to-face communications between any persons with respect to whether the communications are active or not, whether they are talking equally or only one of them is talking one-sidedly, and whether they are angry or laughing. And if a face-to-face contact state cannot be sensed by the infrared sender/receiver (TRIR) due to the location where they are standing, the face-to-face contact state can also be compensated with voice and acceleration information.

The temperature sensor (TRTE) obtains temperatures around the subject terminal (TR) and the illuminance sensor (TRIL) obtains the illuminance in the front direction of the subject terminal (TR) respectively. Consequently, it comes to be possible to record the ambient conditions around the terminal. For example, according to the temperature and illuminance obtained by those sensors, it can also be known that the subject terminal (TR) has moved from a place to another.

The input/output unit (TRI) corresponds to its terminal (TR) wearing person. The input/output unit (TRI) includes a button (TRIB), a display (TROD), a buzzer (TRIS), etc. The input/output unit (TRI) may also include other input/output devices.

The recording unit (TRME) is an external recording unit such as a hard disk, memory, or SD card. The recording unit (TRME) records items of terminal identification data (TRME), sensing interval, and such operation setting (TRMA) as the output contents to a display. The terminal identification data (TRME) is a unique identification number of the terminal (TR). The recording unit (TRME) can also store, for example, sensing data temporarily, as well as programs to be executed by the CPU (not shown) of the control unit (TRCO).

The watch (TRCK) holds time information and updates the time information periodically. The watch (TRCK) adjusts the time periodically in accordance with the time information received from its gateway (GW), thereby synchronizing the time information among all the terminals (TR).

The control unit (TRCO) includes a CPU (not shown). The CPU executes the programs (not shown) stored in the recording unit (TRME), thereby executing the processings such as operational control (TRCC), sensor control (TRSC), time synchronization (TRCS), radio traffic control (TRCC), association (TRTA), etc. required for controlling the terminal.

The operational control (TRCC) is a processing for controlling all the processings executed by the control unit (TRCO).

The sensor control is a processing for controlling the sensing interval, etc. of each sensor in the sensing unit (TRSE) according to the operation setting (TRMA) to administrate obtained data.

The time synchronization (TRCS) is a processing for obtaining time information from a gateway (GW) to adjust the watch (TRCK) of the subject terminal (TR). The time synchronization (TRCS) may be executed just after the association processing or may be executed according to the time synchronization command received from the gateway (GW).

The radio traffic control (TRCC) is a processing for controlling sending intervals upon sending/receiving data and formats the data in accordance with the data format corresponding to the radio signal sending/receiving. The radio traffic control (TRCC) may include wired communication functions as needed. Sometimes, the radio traffic control (TRCC) executes congestion controlling so as not to disturb the sending timings of other terminals (TR).

The association (TRTA) is a processing for sending/receiving a command for forming a personal area network (PAN) to/from an object gateway (GW) and decides a gateway (GW) to which data is to be sent. The association (TRTA) processing is executed when the terminal (TR) is powered or when the terminal (TR) moves to another place, thereby the communication with the gateway is disconnected. Upon the execution of the association (TRTA) processing, the terminal (TR) is related to one gateway (GW) that can receive the radio signal from the terminal (TR).

The sender/receiver unit (TRSR) includes an antenna for sending/receiving radio signals. The sender/receiver unit (TRSR) can also send/receive the radio signals with use of a wired communication connector as needed.

The gateway (GW) functions to mediate between the terminal (TR) and the sensor-net server (SS). By taking consideration to the radio arrival distance, plural gateways (GW) may be disposed so as to cover a wider area including the living room/office, etc.

The gateway (GW) includes a sender/receiver unit (BASR), a recording unit (GWME), a watch (GWCK), and a control unit (GWCO).

The sender/receiver unit (BASR) receives radio signals from terminals (TR) and sends the radio signals to the gateway (GW) by wiring or by radio. Furthermore, the sender/receiver unit (BASR) includes an antenna for sending/receiving signals by radio.

The recording unit (GWME) is composed of an outboard recorder such as a hard disk, memory, or SD card. The recording unit (GWME) stores items of operation setting (GWMA), data format information (GWMF), terminal administration table (GWTT), and gateway information (GWMG). The operation setting (GWMA) includes information denoting how to operate the object gateway (GW). The data format information (GWMF) includes information denoting a communication data format, as well as information required for tagging sensing data. The terminal administration table (GWTT) includes terminal identification data (TRMT) of associated terminals (TR), as well as local identification data distributed to those terminals (TR) so as to administrate them under the control of the gateway (GW). The gateway information (GWMG) includes the address, etc. of the gateway (GW) itself.

Furthermore, the recording unit (GWME) may also store programs to be executed by the CPU (not shown) of the control unit (GWCO).

The watch (GWCK) holds time information and updates the time information periodically. Concretely, the watch (GWCK) adjusts the time information in accordance with the time information obtained from an NTP (Network Time Protocol) server (TS) periodically.

The control unit (GWCO) includes a CPU (not shown). The CPU executes the programs stored in the recording unit (GWME) to administrate the sensing data sensor information acquisition timing, sensing data processing, timings of sending/receiving to/from the terminals (TR) and the sensor-net server (SS), and time synchronization timing. Concretely, the CPU executes the programs stored in the recording unit (GWME) to execute the processings of radio traffic control/transmission control (GWCC), data format discrimination (GWDF), association (GWTA), clock synchronization control (GWCD), and clock synchronization (GWCS), etc.

The radio traffic control/transmission control (GWCC) controls the timings of communications with the terminals and the sensor-net server by radio or by wiring. The radio traffic control/transmission control (GWCC) also discriminates types of received data respectively. Concretely, the radio traffic control/transmission control (GWCC) decides whether received data is general sensing data, association data, or clock synchronization response according to the head part of the received data, then passes the data to a proper function.

The data format discrimination (GWDF) discriminates the data format appropriately to the data format for sending/receiving by referring to the recorded data format information (GWMF), then tags the data so as to denote the data type.

The association (GWTA) is a processing for returning a response to an association request from a terminal (TR) and sends the local identification data assigned to each terminal (TR). When the association is established, the association (GWTA) executes the processing of terminal administration data adjustment (GWCD) to adjust the contents in the terminal administration table (GWTT).

The clock synchronization control (GWCD) controls the interval and timing for executing the clock synchronization processing and issues a command for the clock synchronization. The sensor-net server (SS) may execute the clock synchronization control (GWCD) to send the command to all the gateways of the system in an integral manner.

The time synchronization (GWCS) connects the NTP server (TS) on the network, then requests and obtains time information. The time synchronization (GWCS) adjusts the watch (GWCK) according to the obtained time information. The time synchronization (GWCS) sends the time synchronization command and time information to the object terminal (TR).

The sensor-net server (SS) administrates data collected from all the terminals (TR). Concretely, the sensor-net server (SS) stores data received from gateways (GW) in a database and sends sensing data in response to a request from the application server (AS) and the client (CL). Furthermore, the sensor-net server (SS), upon receiving a control command from a gateway, sends the result obtained with the control command to the gateway (GW).

The sensor-net server (SS) includes a sender/receiver unit (SSSR), a recording unit (SSME), and a control unit (SSCO). If the sensor-net server (SS) executes the time synchronization control (GWCD), the sensor-net server (SS) also requires a watch.

The sender/receiver unit (SSSR) sends/receives data to/from a gateway [GW], an application server (AS), and a client (CL). Concretely, the sender/receiver unit (SSSR) receives sensing data from a gateway (GW) and sends the sensing data to the application server (AS) or client (CL).

The recording unit (SSME) is composed of a memory device such as a hard disk or the like and stores at least a performance database (SSMR), data format information (SSMF), a sensing database (SSDB), and a terminal administration table (SSTT). Furthermore, the recording unit (SSME) may store programs to be executed by the CPU (not shown) of the control unit (SSCO).

The performance database (SSMR) is used to record assessment data (performance data) related to a subject organization and its members, inputted from terminals (TR) or existing data together with time data. The performance database (SSMR) is the same as the performance database (PDB) shown in FIG. 1. Performance data is inputted from the input unit (MRPI).

The data format information (SSMF) includes a communication data format, a method for sorting and recording sensing data tagged by gateways (GW) in databases, as well as a method for how to correspond to data requests. After receiving data, this_data format information (SSMF) is always referred to upon executing processings of the data format discrimination (SSDF) and the data sorting (SSDS) before sending data.

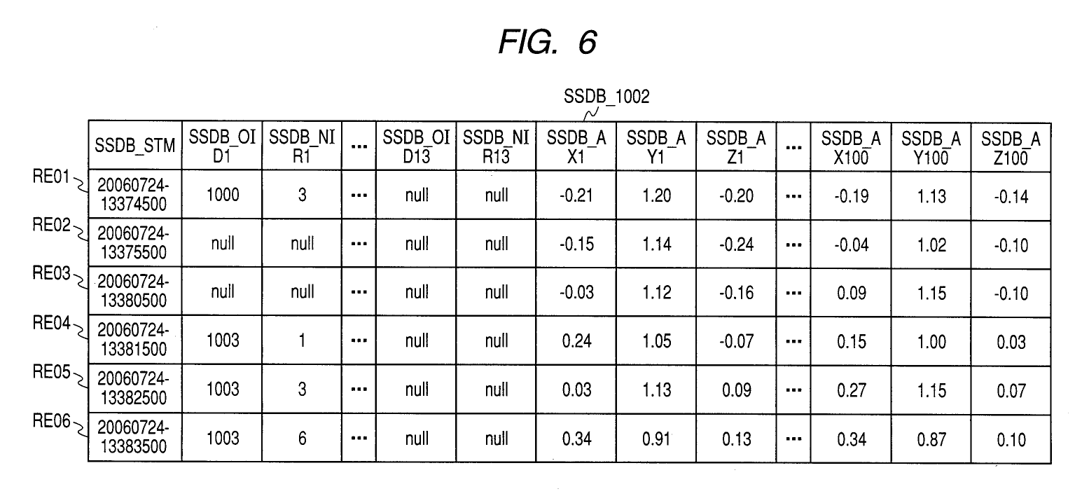

The sensing database (SSDB) is used to record sensing data obtained by each terminal (TR), terminal (TR) identification data, and information of each gateway (GW) through which sensing data obtained by each terminal (TR) has passed, etc. The sensing database (SSDB) has columns created for such elements as acceleration, temperature, etc. respectively, so as to administrate those data. The sensing database (SSDB) may also have tables created for those data elements respectively. In any cases, every data is related to the information obtained terminal (TR) identification data (TRMT), which is the terminal identifier, as well as to the information obtained time information in those columns and tables. FIG. 6 shows a concrete example of the sensing database (SSDB).

The terminal administration table (SSTT) records a current relationship between each terminal (TR) and its gateway (GW). The terminal administration table (SSTT) is updated each time a new terminal (TR) is added to the gateway (GW).

The control unit (SSCO) includes a CPU (not shown) and controls sending/receiving of sensing data, as well as recording/taking out those data to/from each database. Concretely, the CPU executes the programs stored in the recording unit (SSME) to execute the processings of transmission control (SSCC), terminal administration data adjustment (SSTF), and data administration (SSDA), etc.

The control unit (SSCO) controls timings for communicating with gateways (GW), application servers (AS), and clients (CL) by wiring or by radio. The transmission control (SSCC) converts the format of the data for sending/receiving in accordance with the data format of the sensor-net server (SS) or the specified data format of the object remote communication party according to the data format information (SSMF) stored in the recording unit (SSME). Furthermore, the transmission control (SSCC) reads the header part of received data, which denotes a data type and sorts the received data to a corresponding processor. Concretely, received data is sent to the data administration (SSDA) and the command for adjusting terminal administration data is applied to the process of the terminal administration data adjustment (SSTF). The destination of data to be sent is decided to be a gateway (GW), an application server (AS) or a client (CL).

The terminal administration data adjustment (SSTF), when the sensor-net server (SS) receives a command for adjusting terminal administration data from a gateway (GW), updates the terminal administration table (SSTT).

The data administration (SSDA) administrates adjustment/acquisition and addition of data in the recording unit (SSME). For example, sensing data classified into elements according to the tag information are recorded in proper columns in the object database respectively in the process of data administration (SSDA). The sensor-net server (SS), upon reading sensing data from a database, also selects only necessary data according to the time information and terminal identification data and sorts the data in order of the time series.

The sensor-net server (SS) pigeonholes data received through gateways (GW) and stores the data in the performance database (SSMR) and the sensing database (SSDB) in the process of data administration (SSDA). This processing is equivalent to the organization dynamics data collection (BMB) shown in FIG. 1.

The application server (AS) also analyzes and processes sensing data. Upon receiving a request from a client (CL) or automatically at a set time, an analysis application program starts up. The analysis application requests the sensor-net server (SS) to obtain necessary sensing data. Furthermore, the analysis application analyzes the obtained data and returns the result to the object client (CL). The analysis application may also store the analyzed data in an analysis database as is.

The application server (AS) includes a sending/receiving unit (ASSR), a recording unit (ASME), and a control unit (ASCO).

The sending/receiving unit (ASSR) sends/receives data to/from the sensor-net server (SS) and clients (CL). Concretely, the sending/receiving unit (ASSR) receives a command from a client (CL) and sends a data request to the sensor-net server (SS). Then, the sending/receiving unit (ASSR) receives sensing data from the sensor-net server (SS), analyses the data, and sends the analyzed data to the client (CL).

The recording unit (ASME) is composed of an external recording device such as a hard disk, memory, or SD card. The recording unit (ASME) stores analysis setting conditions and analyzed data. Concretely, the recording unit (ASME) stores items of display condition (ASMP), analysis algorithm (ASMA), analysis parameter (ASMP), terminal-person reference table (ASMT), analysis database (ASMD), correlation coefficient (ASMS), and connected table (CTB).

The display condition (ASMP) records display conditions requested from a client (CL) temporarily.

The analysis algorithm (ASMA) records analysis programs. In response to a request from a client (CL), a proper program is selected and data is analyzed under the control of the program.

The analysis parameter (ASMP) records feature extraction parameters, etc. The analysis parameter (ASMP) is rewritten in response to a request from a client (CL).

The terminal-person reference table (ASMT) shows a reference table having items of terminal ID, person name and attribution, etc. for each of terminal wearing persons. Upon a request from a client (CL), a person name is added to a terminal ID of the data received from the sensor-net server (SS). Upon obtaining data of only a person matching with an attribution, this terminal-person reference table (ASMT) is referred to, thereby converting the person's name to terminal identification data and send a data request to the sensor-net server (SS).

The analysis database (ASMD) stores analyzed data. Analyzed data is stored temporarily until it is send to the object client (CL). A mass of analyzed data is also stored in this analysis database (ASMD) so that the data is obtained later collectively. This analysis database (ASMD) is not required if data is sent to a client while the is analyzed.

The correlation coefficient (ASMS) records correlation coefficients decided in the process of correlation coefficient learning (BMD). The correlation coefficient (ASMS) is executed in the process of organization activity analysis (BME).

The connected table (CTB) stores data related to plural terminals aligned in the process of mutual data alignment (BMC).

The control unit ASCO) includes a CPU (not shown) and controls sending/receiving of data and analyzes sensing data. Concretely, the CPU (not shown) executes the programs stored in the recording unit (ASME) to execute the processings of transmission control (ASCC), analysis condition setting (ASIS), mutual data alignment (BMC), correlation coefficient learning (BMD), terminal-user collation (ASDU), etc.

The transmission control (ASCC) is a processing for controlling the timings of communications with the sensor-net server (SS) and clients (CL) by wiring or by radio. In addition, the transmission control (ASCC) executes data format discrimination and sorts destinations according to data types.

The analysis condition setting (ASIS) is a processing for receiving analysis conditions set by the user through a client (CL) and records the conditions in the column of the analysis condition (ASMP) of the recording unit (ASME). Furthermore, the analysis condition setting (ASIS) creates a command for requesting data to a server, then sends a data request the server (ASDR).

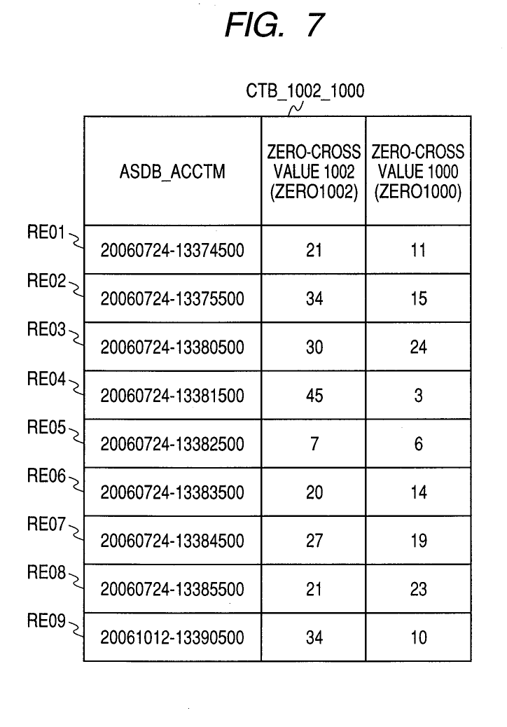

Data received from a server in response to a request set in the analysis condition setting (ASIS) is pigeonholed according to the time information of the data related to any two persons in the process of the mutual data alignment (BMC). This process is equivalent to the mutual data alignment (BMC) shown in FIG. 1. FIG. 7 shows an example of a pigeonholed connected table. If time information is arranged in order, no table creation is required.

The correlation coefficient learning (BMD) is a process equivalent to the correlation coefficient learning (BMD) shown in FIG. 1. The correlation coefficient learning (BMD) is executed with use of the analysis algorithm (ASMA) and the result is recorded in the column of the correlation coefficient (ASMS).

The organization activity analysis (BME) is a process equivalent to the organization activity analysis (BME) shown in FIG. 1. The organization activity analysis (BME) obtains a recorded correlation coefficient (ASMS) and is executed with use of the analysis algorithm (ASMA). The execution result is stored in the analysis database (ASMD).

The terminal-user collation (ASDU) is a process for converting data administrated according to terminal identification data (ID) to a terminal wearing user name, etc. with reference to the terminal-user reference table (ASMT). Furthermore, the terminal-user collation (ASDU) may include additionally user information such as his/her division, post, etc. If not required, the terminal-user collation (ASDU) may not be executed.

A client (CL) inputs/outputs data for its user. The client (CL) includes an input/output unit (CLIO), a sender/receiver unit (CLSR), a recording unit (CLME), and a control unit (CLCO).

The input/output unit (CLIO) functions as an interface with the user (US). The input/output unit (CLIO) includes a display (CLOD), a keyboard (CLIK), a mouse (CLIM), etc. The input/output unit (CLIO) can also connect other input/output devices to its external input/output (CLIU) as needed.

The display (CLOD) is an image display unit such as a CRT (Cathode-Ray Tube), a liquid crystal display, or the like. The display (CLOD) may include a printer, etc.

The sender/receiver unit (CLSR) sends/receives data to/from the application server (AS) or sensor-net server (SS). Concretely, the sender/receiver unit (CLSR) sends analysis conditions to the application server (AS) and receives the analysis result.

The recording unit (CLME) is composed of an external recording unit such as a hard disk, memory, SD card, or the like. The recording unit (CLME) stores information necessary for drawing, such as the analysis condition (CLMP), drawing setting information (CLMT), etc. The analysis condition (CLMP) records conditions such as the number of members to be analyzed, selection of an analysis method, etc., set by the user (US). The drawing setting information (CLMT) records information related to plotting positions on the subject drawing. Furthermore, the recording unit (CLME) may store programs to be executed by the CPU (not shown) of the control unit (CLCO).

The control unit (CLCO) includes a CPU (not shown). The control unit (CLCO) inputs analysis conditions from the user (US) and executes drawing, etc. to present the analysis result to the user (US). Concretely, the CPU executes the programs stored in the recording unit (CLME) to execute the processings of transmission control (CLCC), analysis condition setting (CLIS), drawing setting (CLTS), organization activity display (BMF), etc.

The control unit (CLCO) controls the timings of communications with the application server (AS) or sensor-net server (SS) by wiring or by radio. The transmission control (CLCC) also executes data format discrimination and sorts the destinations according to the data types.

The analysis condition setting (CLIS) is a process for receiving analysis conditions specified by the user (US) in the process of the input/output unit (CLIO) and records the conditions in the column of the analysis condition (CLMP) of the recording unit (CLME). Here, an analysis data period, an analysis type, analysis parameters, etc. are set. The subject client (CL) sends those settings to the application server (AS) and requests the server (AS) to analyze the data, then executes the process of the drawing setting (CLTS) in parallel to the analysis.

The drawing setting (CLTS) is a process for finding a method for drawing an analysis result and a position for plotting the drawing according to the analysis condition (CLMP). This processing result is recorded in the column of the drawing setting information (CLMT) provided in the recording unit (CLME).

The organization activity display (BMF) is a process for creating a figure by plotting the analysis result obtained from the application server (AS). As an example, the organization activity display (BMF) plots such displays as the organization activity display (BMF) shown in FIG. 1, a radar chart, as well as a time series graph, and representation of organization structure. At this time, the organization activity display (BMF) also displays such attributions as the displayed person's name, etc, as needed. The created display result is presented to the user (US) through such an output device as the display (CLOD). The user can also make fine adjustments for display positions through drag and drop operations.

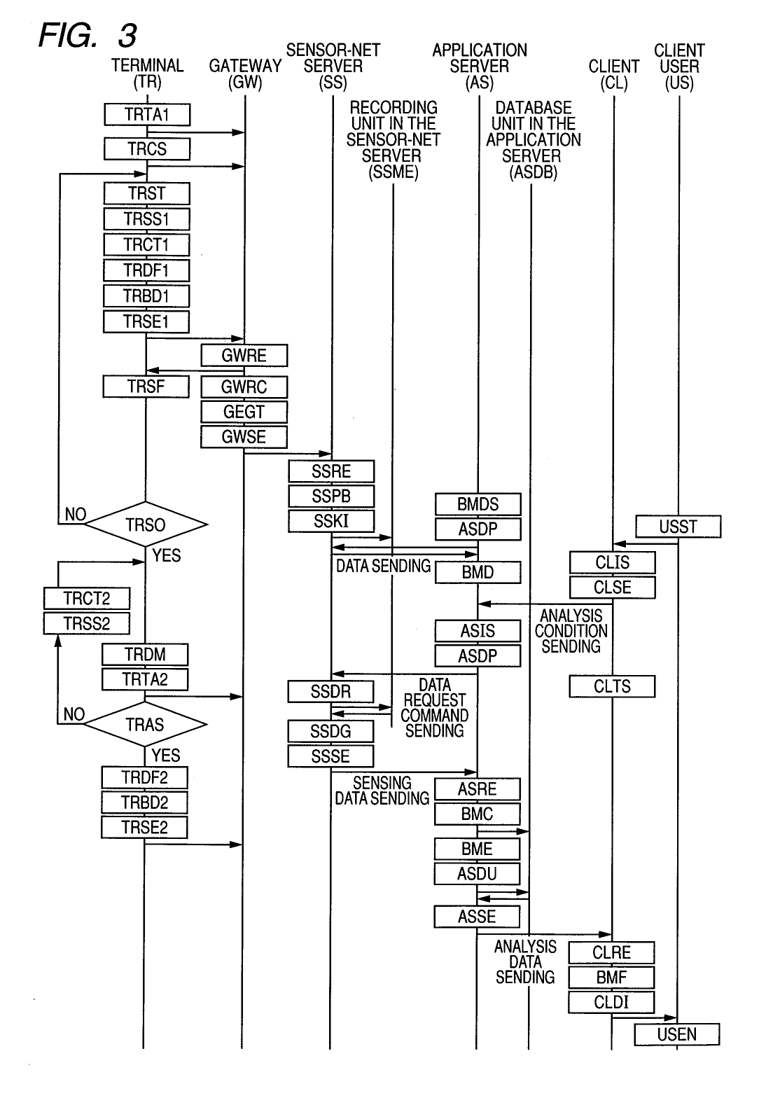

FIG. 3 shows a sequence chart denoting a process for displaying a relationship between organization members according to the data obtained by terminals (TR).

At first, when the subject terminal (TR) is powered, but not associated with any gateway (GW) yet, the terminal (TR) executes the process of association (TRTA1). The association means defining that a terminal (TR) has a relationship with a gateway (GE) to make communications. When a data sending destination is decided through this association, the terminal (TR) is assured to send data to the destination.

If the association is done successfully, the terminal (TR) executes the process of time synchronization (TRCS). In this process of time synchronization (TRCS), the terminal (TR) receives time data from the gateway (GW) and sets the data in the watch (TRCK) built therein. The gateway (GW) adjusts the time by connecting the NTP server (TS) periodically. Consequently, the time is synchronized among all the terminals (TR). As a result, time information attached to each data can be collated and mutual physical expressions or voice information exchanges in communications can be analyzed.

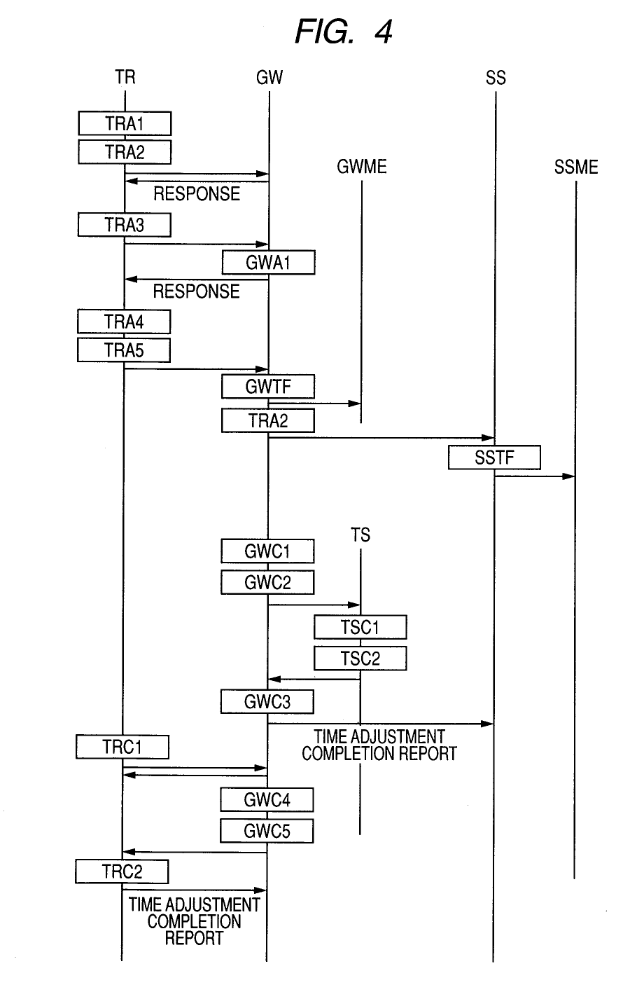

The details of the processes of the association (TRTA1) and the time synchronization (TRCS) will be described later with reference to FIG. 4.

The sensor control unit (TRSC) executes the process of timer start-up (TRST) in a certain cycle, for example, every 10 seconds to sense the acceleration, voice, temperature, illuminance, etc. (TRSS1). The subject terminal (TR) sends/receives the terminal identification data to/from another terminal (TR) with infrared signals to sense the face-to-face contact state. The sensor control unit (TRSC) may keep sensing without executing the process of timer start-up (TRST). However, it is also possible to start up the timer periodically to use the power supply efficiently. This makes it possible to keep using the terminal (TR) for a longer time without charging.

The terminal (TR) adds time information of the watch (TRCK) and terminal identification data (TRMT) to the sensing data (TRCT1). The terminal identification data (TRMT) identifies the terminal (TR) wearing person. The time information is used as a key for arranging data of plural persons in the process of mutual data alignment (BMC) later. Thus the time information is indispensable.

The processes of sensing (TRSS1) and terminal identification data and time addition (TRCT1) are equivalent to the process of organization dynamics data acquisition (BMA) shown in FIG. 1.

On the other hand, each terminal (TR) wearing person inputs a performance value through the terminal (TR) or client (CL). The inputted value is recorded in the sensor-net server (SS). If indicators of the entire organization such as sales, stock price, etc. are used as performance values, the representative of the organization may input those values collectively and upon updating of those values, updated indicator values may be inputted automatically.

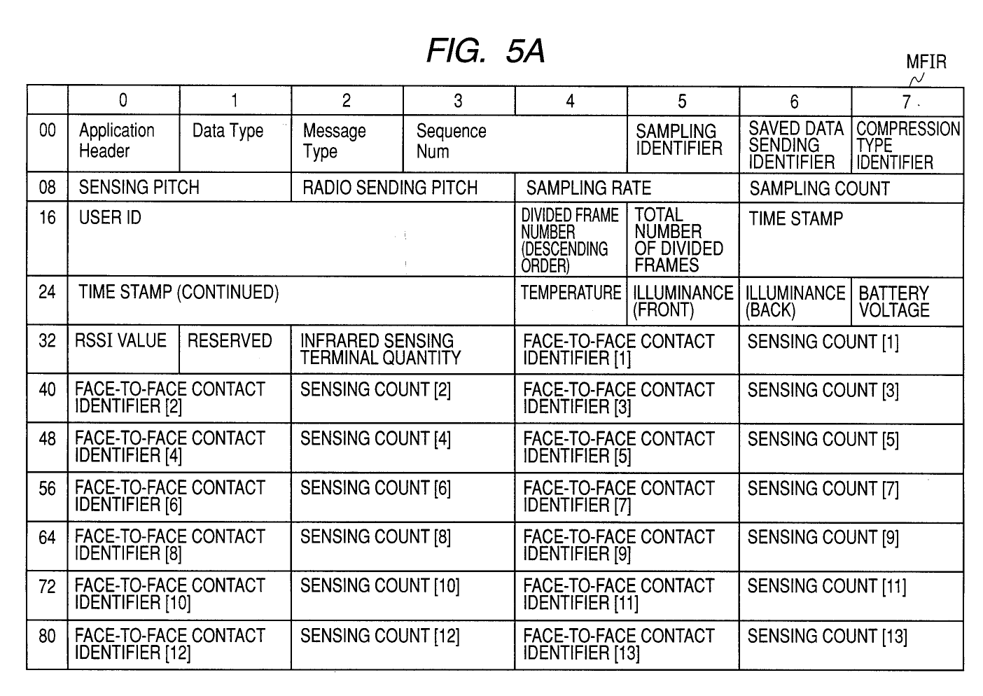

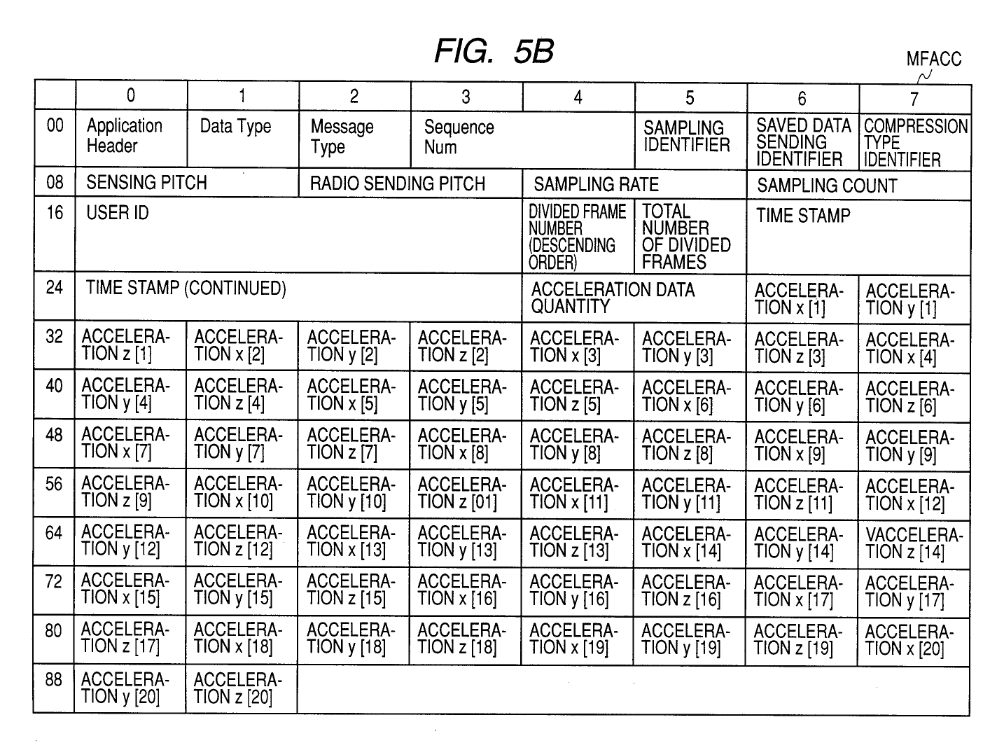

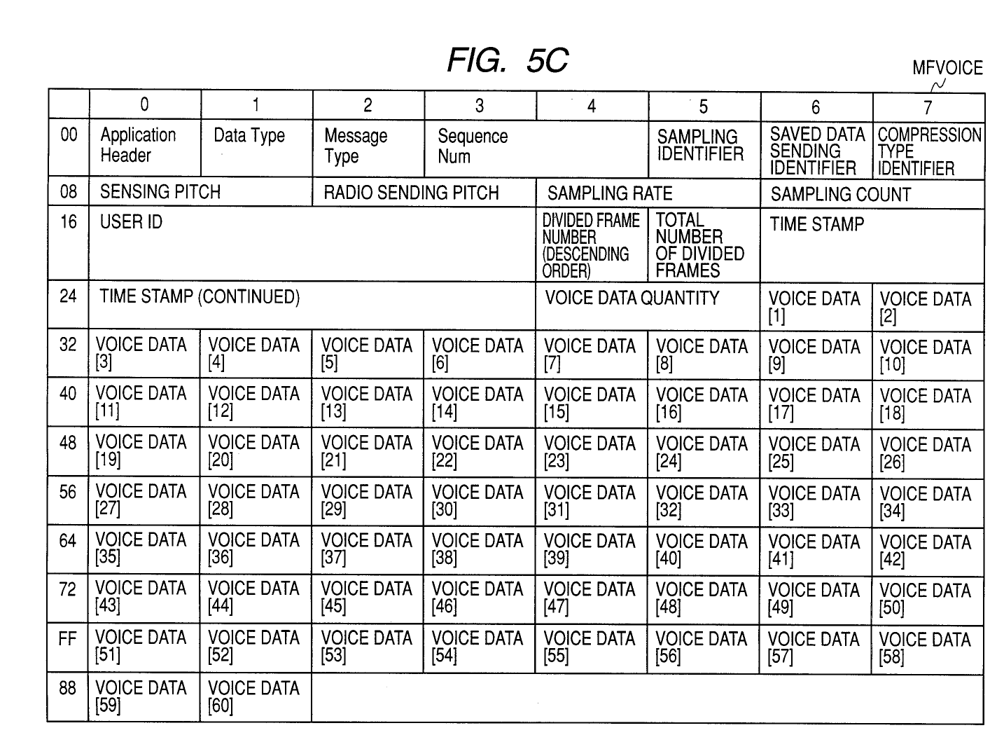

In the process of data format discrimination (TRDF1), the subject terminal (TR) formats the sensing data and sensing conditions according to the predetermined radio transmission format as shown later in FIG. 5. The newly formatted data is then sent to the gateway (GW) (refer to the TRSE1).

Upon sending a mass of consecutive data such as acceleration data, voice data, or the like, the terminal (TR) limits the number of data to be sent at a time in the process of data division (TRBD1), thereby lowering the risk of data missing.

The process of data sending (TRSE1) sends data to an associated gateway (GW) through the sender/receiver unit (TRSR).

The gateway (GW), upon receiving data from a terminal (TR), returns the response to the terminal (TR). Receiving the response, the terminal (TR) regards it as sending completion (TRSF).

If the process of sending completion (TRSF) is not ended even after a certain time (the terminal (TR) does not receive a response), the terminal (TR) decides it as a data sending error (TRSO). In this case, the data is stored in the terminal (TR) and sent together with other data collectively when the sending state is established again. Consequently, the data is always obtained with no break even if the terminal (TR) wearing person moves to a place where the radio is not received or when data receiving is disabled due to a trouble in the gateway (GW). Thus the statistical characteristics of the subject organization can be obtained stably.

Next, there will be described the process of saved data sending. A terminal (TR), when there is any data that cannot be sent out, stores the data once therein (TRDM), then requests the process of association again to the gateway (GW) (TRTA2). If the terminal receives a response from the gateway (GW) denoting that the association has succeeded, the terminal (TR) executes the processes of data format discrimination (TRDF2), data division (TRBD2), data sending (TRSE2). Those processings are the same as those of data format discrimination (TRDF1), data division (TRBD1), and data sending (TRSE1) described above. Upon the data sending (TRSE2), congestion control is made so as to avoid confliction among radio communications. After this, the processing returns to normal one.

If the association fails, the terminal (TR) executes the processes of sensing (TRSS2) and terminal identification data/time addition (TRCT2) until the association succeeds. The processes of sensing (TRSS2) and terminal identification data/time addition (TRCT2) are equivalent to those of sensing (TRSS1) and terminal identification data/time addition (TRCT1) described above. Data obtained by those processings is stored in the terminal (TR) until the sending to the gateway (GW) succeeds.

The gateway (GW) then decides whether or not the received data is divided according to the divided frame number shown in FIGS. 5A through 5C. If the data is divided, the gateway (GW) executes the process of data join (GWRC) to unite the divided data into one continuous data. Then, the gateway (GW) adds the gateway information (GWMG) that is a unique number to the data (GEGT) and sends out the data through networks (NW) (GWSE). The gateway information (GWMG) can be used for the data analysis processing as information denoting roughly the location of the subject terminal (TR) at that time.

The sensor-net server (SS), upon receiving data from a gateway (GW) (SSRE), classifies the data into elements such as time, terminal identification data, acceleration, infrared, temperature, etc. (SSPB) in the process of data administration (SSDA). This classification is executed by referring to the format (see FIGS. 5A through 5C) recorded as the data format information (SSMF). Classified data is stored in proper columns in the record (row) of the subject database respectively (SSKI). At this time, because data corresponding to the same time are stored in the same record, data searching is enabled in the process of time and terminal identification data (TRMT).

At this time, a table may be created for each terminal identification data (TRMT) as needed.

The processings described so far are equivalent to the process of organization dynamics data collection (BMB) shown in FIG. 1.

The application server (AS) learns a correlation coefficient periodically. This correlation efficient learning means finding a correlation coefficient between performance and sensing data according to the data collected in a period ranged from a few weeks to a few months, thereby updating the correlation between them. A concrete method for learning a correlation coefficient is shown in the process of the correlation coefficient learning (BMD) shown in FIG. 1.

The correlation efficient learning is executed as follows. At first, the application server (AS) starts up the learning process in a set period (BMDS) and sends a necessary data request command to the sensor-net server (SS) (ASDP) to obtain the data related to the subject sensing data and performance from the sensor-net server (SS). The application server (AS) then makes the correlation coefficient learning according to the obtained data (BMD).

Next, there will be described the procedure of organization activity analysis (BME). At first, the user (US) starts up an analysis process (USST). Then, the process of organization activity analysis (BME) starts. The client (CL) requests the user to input concrete settings such as a desired analysis type, etc. and sets analysis conditions according to the input (CLIS). At this time, the client (CL) may display a setting window, etc. for the user (US). The client (CL) sends the set analysis conditions to the application server (AS) (CLSE). Then, the client (CL) executes the procedure of drawing setting (CLTS).

The application server (AS) then sets the analysis conditions received from the client (CL). After this, the application server (AS) creates a data request command and sends the command to the sensor-net server (SS) (ASDP).

The sensor-net server (SS) then searches the requested sensing data according to the request command (SSDR) and obtains the necessary data (SSDG). The sensor-net server (SS) then sends the obtained data to the application server (AS) (SSSE).

The application server (AS), upon receiving the data from the sensor-net server (SS) (ASRE), executes the processes of mutual data alignment (BMC) and organization activity analysis (BME). The processes of mutual data alignment (BMC) and organization activity analysis (BME) are equivalent to those shown in FIGS. 1 and 2.

After this, the application server (AS) adds the user name and attribution information corresponding to the terminal identification data to the analyzed data in the process of terminal-user collation (ASDU), then sends the analyzed data to the client (CL) (ASSE).

The client (CL) receives analyzed data (CLRE), creates an organization activity display (BMF), and displays the created organization activity on an output device such as a display (CLDI). The contents of the organization activity display (BMF) are the same as those shown in FIGS. 1 and 2.

The user (US) checks the displayed analysis result and executes the process of analysis completion (USEN).

FIG. 4 shows a sequence chart for describing the processes of association and time synchronization executed in this first embodiment of the present invention.

Concretely, FIG. 4 shows detailed sequences of the processes executed by a terminal (TR), a gateway (GW), and the sensor-net server (SS) in the processes of association (TRTA1 and TRTA2), as well as time synchronization (TRCS).

At first, there will be described the process of association (TRTA). The processes from association not established (TRA1) to terminal administration data adjustment (SSTF) shown in FIG. 4 are equivalent to the processes of association (TRTA1) and (TRTA2) shown in FIG. 3.

If a terminal (TR) is in a place where communications with any gateways (GW) are disabled just after it is powered, the state is referred to as association not established (TR1). In this state, the terminal (TR) sends out a gateway search command by radio and periodically (TRA2). If any gateway (GW) near the terminal (TR) receives this command, the gateway (GW) returns a response to the terminal (TR).

Receiving the response, the terminal (TR) sends an association request (TRA3) to the gateway (GW). The gateway (GW), upon receiving the request, sets a local identifier for the terminal (TR) and distributes the identifier to the terminal (TR) (GWA1). As a result, a personal area network (PAN) is established, thereby the association is established between the gateway (GW) and the terminal (TR).

When the association is established (TRA4), the terminal (TR) sends a request for correcting the terminal administration data to the gateway (GW) (TRA5). Upon receiving the request, the gateway (GW) adds the new terminal MAC address and the local identifier to the terminal administration table (TRTT) provided in the recording unit (GWME) to update the table contents (GWTF). Furthermore, the gateway (GW) sends the terminal administration data to the sensor-net server (SS) (TRA2). The information denotes that the gateway (GW) is administrating the terminal (TR). Upon receiving the information, the sensor-net server (SS) updates the terminal administration table (SSTT) that relates the gateway (GW) to the terminal (TR) (SSTF) according to the received information.

The sensor-net server (SS) can administrate the correspondence between each terminal (TR) and each gateway (GW) by keeping updating of the terminal administration data. The sensor-net server (SS) can refer to the updated terminal administration data upon downward sending to the terminal (TR).

Next, there will be described a reason why local identification data is distributed to the subject terminal (TR) in the process of association. In the process of association request (TRA3), a single address (MAC address) common to all the terminals (TR) is sent to all those terminals (TR). However, there are too many digits in the MAC address, so that it is not suitable for ordinary radio data communications. This is why a gateway (GW), upon establishing communications with a terminal (TR), assigns local identification data to the terminal (TR). The local identification data uses less digits and is used only in its corresponding personal area network (PAN). This local identification data is added to ordinary data sending from a terminal (TR) to a gateway (GW). A gateway (GW), upon receiving data from a terminal (TR), converts the local identification data added to the data to the MAC address and sends the MAC address added data to the sensor-net server (SS).

Next, there will be described the process of time synchronization. The processes from time request sending (TRC1) to time adjustment (TRC2) shown in FIG. 4 are equivalent to the process of time synchronization (TRCS) shown in FIG. 3.

The gateway (GW) executes the process of timer start-up (GWC1) periodically to connect the NTP sever (TS) existing on the external or internal network to adjust the watch (GWCK) built there (GW). Hereunder, there will be described the details of the process.

A gateway (GW), after executing the time start-up (GWC1), sends a time request to the NTP server (TS) (GWC2). Receiving the time request, the NTP server (TS) (TSC1), sends the correct time information to the gateway (GW) (TSC2). The gateway (GW) thus adjusts the time according to the received correct time information (GWC3) and returns a time adjustment completion report to the sensor-net server (SS). The time is thus synchronized among plural gateways (GW).

On the other hand, each terminal (TR) receives the time information from a gateway (GW) at a predetermined event (e.g., association establishment) to adjust its watch (TRCK). This process will be described below more in detail.

At first, a terminal (TR) sends a time request to a gateway (GW) (TRC1). Receiving the time request (GWC4), the gateway (GW) sends the time information to the terminal (TR) (GWC5). The terminal (TR) thus adjusts its time information according to the received time information (TRC2), then returns a time adjustment completion report to the gateway (GW). The time is thus synchronized among plural terminals (TR). As a result, cross-correlation analysis, etc. are enabled between plural persons wearing those terminals (TR) respectively.

FIGS. 5A through 5C show examples of payload formats used for sending sensing data obtained by terminals (TR) by radio. As a preferable radio communication standard employed for this payload, for example, IEEE802.15.4 is used.

Each of infrared data (FIG. 5A), acceleration data (FIG. 5B), and voice data (FIG. 5C) is sent using its own format, since the number of data to be sent at a time is limited. Because acceleration data and voice data are sent/received as continuous data respectively, they are often divided and sent when the data is too many in quantity. Divided data are integrated again in the subject gateway (GW) and the integrated data is tagged. In the case of radio communications, a radio communication format is defined so as to make the length of sending data as short as possible. Tags, etc. that cannot be sent in this format are added in the subject gateway (GW) respectively. The radio sending formats shown in FIGS. 5A through 5C are recorded in the data format information (TRMF) in each terminal and in the data format information (GWMF) in each gateway (GW).

FIG. 5A shows an IR data format (MFAIR) for sending infrared data by radio in this first embodiment of the present invention.

In the format shown in FIG. 5A, the 0-th to 27th bytes are equivalent to the 0-th to 27th bytes shown in FIGS. 5B and 5C. Consequently, the description for the 0-th to 27th bytes also apply to those shown in FIGS. 5B and 5C.

The ApplicationHeader in the 0-th byte denotes that the subject data is related to the business microscope system in this first embodiment. The “subject data” mentioned here means sensing data sent in the format shown in FIG. 5A.

The DataType in the 1st byte denotes a format type. In other words, the 1st byte denotes that the subject data is any of infrared data, acceleration data, and voice data. The subject gateway (GW) checks the type of each received data and tags the data according to this DataType. Tagged data is stored in a database of the sensor-net server (SS).

The MessageType in the 2nd byte denotes that the subject data is any of a data command, a response to a command, and an event.

The SequenceNum in the 3rd and 4th bytes is one of the serial numbers between 0000 to FFFF to be added to each obtained data. The SequenceNum is used to confirm whether or not the subject gateway (GW) has received all the object data. When the SequenceNum reaches FFFF, 0000 is added to the next obtained data cyclically. Hereinafter, the SequenceNum added data increases one by one sequentially.

The sampling identifier in the 5th byte denotes that plural divided data are sampled in the same sensing pitch. In the example shown in FIG. 5A, the 88-byte data between the 0-th and 87th are sent as one frame payload.

The saved data sending identifier in the 6th byte denotes whether or not the subject data is sent in the process of saved data sending. Saved data sending means a processing for saving data in the subject terminal (TR) once if the data sending to the object gateway (GW) is disabled, then sending the saved data collectively. By referring to this saved data sending identifier, it is known that the subject terminal (TR) wearing person had been outside of the gateway (GW) area once due to an outing, or the like.

The compression identifier in the 7th byte denotes whether or not the subject data is compressed. If the subject data is compressed, the compression identifier further includes information denoting the compression method. If the subject data is acceleration data or voice data, the data is often compressed, since the data is large in quantity. Sending the data compressed as described above is assured in this state. If the subject data is compressed, the gateway (GW) or sensor-net server (SS) decompresses the data.

The sensing pitch in the 8th and 9th bytes denotes one cycle pitch consisting of a sensing state and an idling state of the subject terminal (TR).

The radio sending pitch in the 10th and 11th bytes denotes a radio sensing data sending pitch. Usually, this radio sending pitch should preferably be an integer multiple of the sensing pitch.

The sampling rate set in the 12th and 13th bytes denotes a sensing interval.

The sampling count set in the 14th and 15th bytes denotes the number of times for specifying continuous sensing. When sensing is terminated at this sampling count, the state until the next cycle starts becomes an idling state. The subject terminal (TR) can realize lower power consumption by repeating such intermittent operations. The terminal (TR) may also be set so as to keep sensing with no breaks.

The user ID set in the 16th to 19th bytes denotes a number denoting a terminal (TR) wearing person. If the terminal (TR) wearing person is changed to another, this user ID can also be rewritten.

The total number of divided frames set in the 21st byte denotes the number of divided data obtained in one cycle when sensing data (particularly acceleration or voice data) is divided and sent out. The subject gateway (GW) unites received divided data into one original data in an ascending order of the divided frame numbers (GWRC).

The divided frame number set in the 20th byte denotes each divided frame number in all the frames of the original data in a descending order. The last frame number is 0. This makes it easier to find missing frames during the sending.

The time stamp set in the 22nd to 27th bytes denotes the starting time of each sensing pitch. The time stamp value is obtained from the watch (TRCK) built in the subject terminal (TR). This time stamp is stored in the sensing database shown in FIG. 6 as a starting time (SSDB_STM).

In the infrared data format (MFIR), temperature data (the 28th byte), illuminance data (29th and 30th bytes), battery voltage (31st byte), RSSI value (32nd byte), etc. are set in and after the 28th byte as needed. An illuminance sensor (TRIL) may be provided at the front and back of each subject terminal (TR) respectively to distinguish between the front and back of the terminal (TR). In this case, a one-byte area is secured for the illuminance data at each of the front and back of the terminal.

The battery voltage denotes a residual voltage of the battery (not shown) built in the subject terminal (TR). The RSSI value (RSSI (Received Signal Strength Indication)) denotes a radio wave strength when the subject terminal (TR) is associated with a gateway (GW). This RSSI value makes it possible to roughly know the distance between the terminal (TR) and the gateway. The reserved (33rd byte) denotes a reserved area.

In the infrared sending process, the terminal (TR) sends out the lower 4 digits of its own MAC address (terminal identification data) several times in one sensing pitch. The terminal (TR) is always ready for receiving infrared signals. Upon receiving the 4-digit address, the terminal (TR) counts the number of receiving times of the MAC address from the subject terminal (TR) in one sensing pitch. The terminal (TR) then assumes the 4-digit address as a face-to-face contact identifier and sends the address receiving count to the gateway as the number of sensing times (GW).

The 36th and 37th bytes are used to set a face-to-face contact identifier. The 38th and 39th bytes are used to set a receiving count (sensing count) of the gave-to-face contact identifier denoted by the 36th and 37 bytes. Similarly, the 40th to 87th bytes are used to register a set of 12 face-to-face contact identifiers and a sensing count.

In other words, the infrared data format shown in FIG. 5A enables receiving of infrared signals from 13 terminals (TR) in maximum in one sensing pitch. If infrared signals are received from less than 13 terminals (TR) in one sensing pitch, more than one set of face-to-face contact identifiers and a sensing count becomes blank while data formatted as shown in FIG. 5A is sent out. The number of terminals (TR) that have sensed infrared signals denoted by the 34th and 35th bytes denotes the number of sets of face-to-face contact identifiers and a sensing count (data exists in those sets (not empty)).

FIG. 5B shows an acceleration data format (MFACC) used for sending acceleration data by radio in this first embodiment of the present invention.

The 0-th to 27th bytes in the acceleration data format are equivalent to those in the infrared data format (MFAIR), so that the description for them will be omitted here.

In the acceleration data format (MFACC), the number of acceleration data set in the 28th byte denotes the number of sets of acceleration data in all the directions of the X, Y, and Z axes, included in one frame sending format. In the example shown in FIG. 5B, 20 sets of acceleration data are included in one frame sending format. Acceleration data is registered sequentially in and after the next 30th byte.

FIG. 5C shows a voice data format (MFVOICE) used for sending voice data in this first embodiment of the present invention.

The 0-th to 27th bytes in this voice data format (MFVOIVE) are equivalent to those in the infrared data format (MFAIR), so that the description for them will be omitted here.

In the voice data format (MFVOICE), the number of voice data set in the 28th byte denotes the number of voice data included in one frame sending format. In the example shown in FIG. 5, 60 voice data are included in one frame sending format. Voice data is registered sequentially in and after the next 30th byte.

FIG. 6 shows a concrete example of a sensing database (SSDB) in this first embodiment of the present invention.

The sensing database (SSDB) is stored in the recording unit (SSME) of the sensor-net server (SS). The sensing database (SSDB) is equivalent to the data table used in the process of organization dynamics data collection (BMB) shown in FIG. 1. In the example shown in FIG. 6, it is assumed that a table is created for each terminal (TR) and a table SSDB_1002) corresponding to the terminal (TR) of which ID is 1002 is shown. The sensing database (SSDB_1002) shown in FIG. 6 stores sensing data received from the terminal (TR) of which ID is 1002.

Data obtained by a terminal (TR) is arranged in one of the radio sending formats shown in FIGS. 5A through 5C and sent to the object gateway (GW). The gateway (GW) then reads meaning information of the radio sending data from the radio sending format and tags the data in the XML format or the like, then sends the tagged data to the sensor-net server (SS). The control unit (SSCO) of the sensor-net server (SS) pigeonholes the received data in the process of data administration (SSDA) and stores the data in the sensing database (SSDB).

The table (SSDB_1002) includes columns for items of time (SSDB_STM), IR sender ID 1) (SSDB_OID1), received number of times 1 (SSDB_NIRI), infrared sender ID 13 (SSDB_OID13), received number of times 13 (SSDB_NIR13), acceleration x1 (associationX1) (SSDB_AX1), acceleration y1 (accelerationY1) (SSDB_AY1), acceleration z1 (SSDB_AZ1, acceleration x100 (SDB_AX100), acceleration y100 (SDB_AY100), and acceleration z100 (SDB_AZ100).

This table further includes columns of received number of times 2 to 12, IR sender IDs 2 to 12, acceleration x2 to x99, acceleration y2 to y99, and acceleration z2 to z99. These columns are omitted in FIG. 6.

The table may further include columns for storing such conditions as voice data, temperature data, illuminance data, sensing pitch, etc. as needed. If it is required to add a time stamp to each of acceleration and voice sensing data, an acceleration data table, a voice data table, etc. may be created independently.

The time (SSDB_STM) stores a time stamp as shown in FIGS. 5A through 5C. In the example shown in FIG. 6, the time (SSDB_STM) stores the time stamp in the format of year, month, day, minutes, seconds, and milliseconds. For example, “20060724-13374500” in the record RE01 denotes “Jul. 24, 2006, 13: 37: 45.00”.

The columns of IR sender ID 1 (SSDB_OID1), received number of times 1 (SSDB_NIR1) to IR sender ID 13 (SSDB_OID13) and received number of times 13 (SSDB_NIR13) store identifier [1], sensing times [1] to face-to-face contact identifier [13] and sensing times [13] respectively in the infrared data format (MFIR).

The columns of acceleration x1 (SSDB_AX1), acceleration y1 (SSDB_AY1), acceleration z1 (SSDB_AZ1), to acceleration x100 (SSDB_AX100), acceleration y100 (SSDB_AY100), acceleration z100 (SSDB_AZ100), acceleration z100 (SSDB_AZ100) store data of acceleration x[1] to acceleration x[100] in the acceleration data format (MFACC). However, the acceleration data to be stored in the table shown in FIG. 6 are values obtained by converting the acceleration from x[1] z[100] in the acceleration data format (MFACC) to the acceleration data in the unit of [G] respectively.

All the data sensed in one sensing pitch are stored in the same record (line) and each record always includes time information. Upon executing mutual data alignment (BMC), each sensing data is related to data obtained from another terminal (TR) with reference to the time information.

FIG. 7 shows a concrete example of a connected table (CTB) in this first embodiment of the present invention.

The connected table (CTB) is stored in the recording unit (ASME) of the application server (AS). The connected table (CTB) is equivalent to the connected table used for mutual data alignment (BMC) shown in FIG. 1. FIG. 7 shows a connected table (CTB_1002_1000) created by connecting zero-cross data sensed by the terminal of which ID is 1002 to zero-cross data sensed by the terminal (TR) of which ID is 1000. The connected table is created for the terminals (TR) to be worn by any two persons belonging to a subject organization or to be subjected to an analysis.

The connected table (CTBab) shown in FIG. 1 stores all of acceleration data, infrared data, and voice data unitarily. However, such a table may be created independently for each type of data as shown in FIG. 7.

The zero-cross data 1002 (ZERO1002) is calculated by counting the number of zero-cross appearing times in 100 acceleration data items in the direction of each axis included in one line in the table (SSDB_1002) shown in FIG. 6 and by totaling the zero-cross data in all the directions of the A, X, and Z axes. Consequently, one terminal (TR) comes to have a zero-cross data with respect to one time information piece.

The data of two terminals (TR) are connected to each other according to their time information. Concretely, the times (SSDB_STM) in two tables (SSDB) (e.g., see FIG. 6) that include the data of two terminals (TR) respectively are collated. And in principle, all the data corresponding to the same time (SSDB_STM) are stored in the same record in the connected table (CTB_1002_1000). In this case, the values of the times (SSDB_STM) corresponding to those data are stored in the time column (ASDB_ACCTM).

However, if the sensing time differs between those two terminals (TR), the times (SSDB_STM) in the tables (SSDB) do not match. In other words, there is no data corresponding to the same time (SSDB_STM) in the two tables (SSDB). In this case, among the data in the two tables (SSDB), two data corresponding to the nearest time (SSDB_STM) are stored in the same record in the table (CTB_1002_1000). At this time, time (ASDB_ACCTM) is calculated according to the original (closest) two times (SSDB_STM). For example, the average of the closest two times (SSDB_STM) may be stored as the time (ASDB_ACCTM).

Basically, the sensing pitch is the same among all the nodes. Thus if a pair of time information pieces is adjusted, other time information pieces are adjusted automatically. If there occurs any data missing due to a sending error, the time deviation occurs among those time information pieces. In this case, the missing data must be compensated by dummy data.

The zero-cross data connected table is used to calculate the cross-correlation between persons. Consequently, it is required to synchronize two data systems (zero-cross data 1002 and 1000 in the example shown in FIG. 7). It is also indispensable to make a comparison between any persons so as to extract organization dynamics with respect to voice and acceleration data. In this case, time synchronization between data of two persons makes it possible to analyze the rhythm of the talking by those persons, the deviation in the number of talking times, as well as a chain of dependence between an action and a face-to-face contact on the basis of the time series. As a result, it becomes possible to make further complicated analyses with respect to the relationship between those persons, and furthermore with respect to the organization dynamics.

The processes of correlation coefficient learning (BMD), organization activity analysis (BME), and organization activity display (BMF) that use this connected table respectively are as described in the example shown in FIG. 1.

Next, there will be described concrete examples for the flows of the processings of calculation of the cross-correlation between persons, calculation of a distance between any persons, grouping, organization structure parameters, and organization structure representation in the process of organization activity analysis (BME) and organization activity display (BMF).

FIG. 8 shows examples of processings of organization activity analysis (BME) and organization activity display (BMF) in this first embodiment of the present invention.

Concretely, FIG. 8 shows examples of processings from calculation of the cross-correlation between persons (EA14) to organization structure representation (FC31) shown in FIG. 1 together with their processing results. The processings from organization dynamics data acquisition (BMA) to personal feature extraction (EA13) are the same as those shown in FIG. 1.

Here, there will be described an example for representing an organization structure by calculating an influence as one of the indicators for representing a relationship between any persons. There can be many indicators used for analyzing such an organization structure, so that those indicators may be calculated here.

FIG. 8 shows an example of an indicator for representing an influence of the person A on the person B with reference to a sample result of representation (SE1) of the calculation of the cross-correlation between persons. This example is for a result of calculation of the correlation between the persons A and B with respect to the acceleration zero-cross data. The processes for up to the calculation of the cross-correlation between zero-cross data of acceleration are similar to the acceleration frequency calculation (EA12), personal feature extraction (EA13), and calculation of the cross-correlation between persons (EA14) in the correlation coefficient learning (BMD) or organization activity analysis (BME). In other words, the calculation of the cross-correlation between persons (EA14) shown in FIG. 8 is equivalent to the calculation of the cross-correlation between persons (EA14) shown in FIG. 1. However, other calculations may be employed here.

The graph of the sample result of representation (SE1) of the calculation of the cross-correlation between persons denotes a time difference □ (minutes) on the horizontal axis and an strength of effect (R_{ab}) on the vertical axis. On the vertical axis, the positive direction denotes positive correlation and the negative direction denotes negative correlation. For example, if the R_{ab} on the horizontal axis 20 (min) denotes a peak value, it means that there is a correlation between actions of the persons A and B with a 20-min interval therebetween. In this case, there is a tendency that the person B moves 20 minutes after the person A moves and this can be interpreted that the person B is affected by the person A.

And it can also be understood that an effect type depends on the correlation appearing interval. For example, if the interval is several milliseconds order, there might be an effect during a face-to-face conversation such as nodding or joint attention. On the other hand, if the interval is several minutes order, the recognized effect might be given by an action (e.g., the person A directs the person B to take an action or the person B follows an action of the person A, etc.).

Furthermore, although the □ always takes a positive value in FIG. 8, calculation is also possible when the □ takes a negative value. The R_{ab} corresponding to a negative □ denotes a peak and it can be interpreted that an action of the person A or an estimation of an action affects the action of the person B before the person A makes an action.

After this, the application server (AS) obtains an indicator representing a relationship between persons with respect to a influence, etc. to calculate a distance between any persons (SEK41). This processing is equivalent to that (EK41) shown in FIG. 1. The relationship indicator and the distance may be the same as those of the organization feature described with reference to FIG. 1 or may be different from those.

At first, the application server (AS) is required to obtain a real number value from the graph of the sample result of the representation of the cross-correlation between persons (SE1) as a relationship parameter (an indicator representing a relationship between persons). At this time, the application server (AS) may obtain the largest peak value in the graph or the result of the calculation of the integration of absolute values in the graph. If the application server (AS) needs extraction of a specific type influence here, the application server (AS) may limit the influence appearing time (a correlation appearing interval), for example, within 0 to 3 minutes to obtain a peak value or an integration of absolute values within the range. In this case, it is considered that the larger the relationship parameter value obtained in such a way is, the stronger the correlation of action between persons becomes, so that the relationship between those persons is regarded to be strong (closer in distance between those persons).

Next, there will be described a case in which an integration of absolute values is used as a relationship parameter. In this case, assume that the power of influence between persons A and B is defined as R_{ab}(τ).

$${T}_{ab} ( 1 ) = {\int }_{τ} \vert {R}_{ab} ( τ ) \vert d τ \qquad ( 4 )$$

Then, the relationship parameter between those persons is represented as shown above.

If there is only one relationship parameter, the real number value is used as the distance of the relationship between the persons A and B as is. If there are plural relationship parameters (e.g., a relationship parameter calculated from infrared or voice is used together with a relationship parameter calculated from acceleration), the relationship between those persons is represented with a relationship vector.

$${T}_{ab} = ( \begin{matrix}{T}_{ab} ( 1 ) \\ {T}_{ab} ( 2 ) \\ ⋮ \\ {T}_{ab} ( n )\end{matrix} ) \qquad ( 5 )$$

Here, the relationship vector element Tab(k) (k=1, 2, . . . , n) is a relationship parameter calculated for the persons A and B. In this case, the strength (distance) of the relationship between the persons A and B is calculated as a relationship distance that is a real number value obtained by totaling weighted relationship parameters.

R_{ab}=α^{T}·T_{ab} (6)

α: Weighted vector

The calculation is made as shown above.

Similarly, the application server (AS) can find a relationship distance between any persons here, then use those elements to extract a relationship distance matrix R (SE21).

The sample result of the representation of a relationship distance between any persons (SE2) denotes an example of a relationship distance matrix R (SE21) and an example of a relationship network (SE22). The example of the relationship network (SE22) is a display of the relationship distance matrix R (SE21) in a simple network diagram style consisting of nodes and links.

Each node displaying A, B, C, and D denotes persons A, B, C, and D. A positive real number displayed near a link between nodes denotes a distance between the persons denoted by those nodes. In the example shown in FIG. 8, the node having a smaller value denotes a closer distance. In other words, the relationship between those persons is strong. Zero (0) means that there is no relationship between those persons.

In the example shown in FIG. 8, the strength of a relationship and the thickness of a displayed link are related to each other. For example, the value of the relationship distance between the persons A and B is 1.0 while the value of the relationship distance between the persons B and C is 0.5. This means that the relationship between the persons B and C is stronger than the relationship between the persons A and B. In this case, the link displayed between the persons B and C is thicker than the link displayed between the persons A and B. In the example shown in FIG. 8, a link between persons who are not related to each other (e.g., the link between the persons A and D) is displayed with a dotted line.

The relationship distance matrix R should preferably be a symmetric matrix, but it may also be an asymmetric matrix if needed.

Next, there will be described a grouping process (SEK42) for sensing a group of persons closer in distance according to a relationship distance matrix found as described above.

In an organization, the members may be related to each another and play diversified roles, for example, members in various business units, contemporary friends, members in same hobby groups, etc. And a person's relationship with others in a hobby group may lead to a success of a business work or may draw a new business inspiration. Consequently, a grouping method to be employed here should preferably be capable of sensing all the groups to which one person belongs.

Furthermore, there are often small groups included in a large group and the members in such a small group may enjoy friendly relations with each another. And the group quality may differ among group scales. Consequently, the grouping method to be employed here should preferably be capable of varying the group partition standard between when in taking a macro view of a configuration of an organization and when in extracting a micro personal relationship between members.

This is why nonexclusive hierarchical grouping is employed here. “Nonexclusive” mentioned here means enabling one element (person) to be included in plural clusters (groups). And this will make it possible to represent and analyze the actual organization structure faithfully.

However, the grouping method is not limited only to those described below and the method may be selected appropriately to the purpose. It is also possible to represent an organization structure by deciding the disposition of the nodes denoting persons only in accordance with the values of the relationship distance matrix without grouping.

Next, there will be described the process for nonexclusive hierarchical grouping. It is intended here to draw a sample (SE2) result of the representation of grouping (SE3) with use of a sample result of the representation of a distance between any persons. The grouping process to be described below is executed by the application server (AS), but it may also be executed by another apparatus (e.g., client (CL)). The grouping result is displayed on the display (CLOD) of the client (CL).

At first, it is assumed here that a network diagram style display (SE22) is obtained as a calculation result of a relationship distance. This is a display of a value of a relationship between any two of the persons A to D on a link. It is premised here that the smaller the value is, the closer the distance is, that is, the stronger the relationship between them is. The value 0 means that there is no relationship between those persons.

Then, two persons having the minimal relationship distance value except for 0 are searched from the relationship network. In the example shown in FIG. 8, the relationship distance between the persons C and D is 0.2 that is the minimal value. In this case, a table-like figure is plotted in the sample result of the representation of grouping (SE3). The figure is composed of two lines approximately in parallel in the vertical direction and a line in the horizontal direction, which connects the upper ends of the two lines in the vertical direction. At this time, the two vertical lines equivalent to two legs of the table-like figure are related to the persons C and D respectively. Then, the height of the table-like figure (the distance between the reference line that is in contact with the lower ends of the two legs and the upper end horizontal line) denotes the relationship distance 0.2 between the persons C and D.

Furthermore, two persons having the next minimal relationship distance value are searched. As a result, the persons C and B having a relationship distance value 0.5 are found. In this case, similarly to the above case, a table-like figure having a height 0.5 is displayed. At this time, the person C is displayed at two places.

The next smaller relationship distance value between the persons B and D is 0.7. Consequently, the relationship among the three persons B, C, and D is clarified together with the already displayed values. At this time, the two figures are displayed: a figure denoting the relationship between the persons C and D and another figure denoting the relationship between the persons C and B. And another table-like figure having a height 0.7 is displayed so as to connect those figures to each other.

In such a way, combinations of persons are extracted in an ascending order of the relationship distance values and a table-like figure is displayed so as to connect those two persons to each other. At this time, if a relationship among three persons is clarified, a table-like figure is displayed so as to connect the already displayed tables to each another. This process is repeated until the maximum relationship distance value is reached, thereby completing the sample result of the representation of grouping (SE3).

In this figure, a relationship distance value to be assumed as a threshold value is decided and the displayed figure is cut into halves at the height of the threshold value. Then, plural groups come to exist under the cutting point in some case. Each of those groups consists of a combination of persons having a relationship distance value smaller than the decided threshold value. If the threshold value increases here, the number of groups under the threshold value also increases. On the other hand, if the threshold value decreases, there appears many small groups, each consisting of a combination of persons having a smaller relationship distance value. In FIG. 8, the threshold value is assumed as 1.5. In this case, the organization consisting of 4 persons is divided into two groups; group 1 consisting of persons B, C, and D and group 2 consisting of persons A and B. And it can be interpreted here that the person B intermediates between those two groups.

With the above processings, organization structure parameters for displaying an organization structure is set (SEK43). In this case, the calculation result of the relationship distance is displayed as a distance between nodes and the grouping result is displayed as a group.

It is also possible here to set organization structure parameters other than the above and have the result reflected on the color or size of the nodes.

After that, in the process of organization structure representation (SFC31), a node (circle or dot) corresponding to each person is disposed on the display screen image according to the set organization structure parameters, thereby displaying the actual organization structure consisting of human relationships. As a result, a display just like the sample result of the representation of organization structure (SE4) is completed.

Upon the displaying, therefore, a node corresponding to each person is reflected in each relationship distance value, thereby enabling well-balanced disposition of nodes. For example, the node of a person belonging to plural groups is displayed as many as the number of groups to which the person belongs and a node belonging to each group may be enclosed in an oval or the like to represent the group. At this time, it should be cared not to make different groups crossed each another.

In the sample result of the representation of the organization structure (SE4), in addition to the groups 1 and 2 cut into halves at the threshold value respectively, small groups consisting of the persons D and C, as well as the persons C and B existing under the group 1 respectively are also displayed in a dotted line circle. Consequently, it is understood that the group 1 consisting of three persons is composed of two small groups. Furthermore, it is understood that the person C intermediates between those small groups and that the person B intermediates between the groups 1 and 2.

As described with reference to FIG. 1, each person's node may be displayed so as to represent the relationship distance between persons. For example, it may be displayed so that the stronger the relationship between persons is (the closer the relationship distance is), the closer the nodes denoting those persons are disposed. Concretely, if the relationship distance between the persons C and D is closer than the relationship distance between the persons A and B, the distance between the node of the person C and the node of the person D is displayed closer than the distance between the node of the person C and the node of the person D (see FIG. 8). As shown in FIG. 1, each connection link between person's nodes may be displayed. In this case, nodes may be displayed so that the closer the relationship distance between persons is, the thicker the link between those persons' nodes becomes.

FIG. 8 shows an example of the calculation of a relationship distance between persons according to the acceleration sensed by a terminal (TR). The relationship distance can also be calculated according to various types of physical information sensed by a terminal (TR). For example, the number of times a terminal (TR) has received an infrared signal from another terminal (TR) for a predetermined period may be used to calculate the relationship distance between those terminals (TR). In this case, it is decided that the more the number of times the infrared signal has received is, the closer the relationship distance is. Otherwise, the voice sensed by the terminal (TR) may be used to calculate the relationship distance between those terminals (TR). In this case, the same method as that of the acceleration cross correlation may be used to calculate the cross-correlation between the voice signals detected by those terminals (TR). In this case, the intensity of the voice signal cross-correlation is assumed as the intensity of the relationship between persons (closer relationship distance between persons).

As described above, an actual organization structure has been successfully extracted from the time series data denoting an action of each person. This organization structure representation reflects the dynamics of the relationship between persons.

According to the first embodiment of the present invention described above, therefore, a relationship between persons can be represented by a value obtained by analyzing such data as infrared, acceleration, and voice sensed by a terminal worn by a person. Furthermore, the relationship between those persons is visualized so as to be understood more easily. Consequently, a relationship between each person of a subject organization and the organization performance is clarified, thereby a positive growth cycle can be realized to improve both the organization and its members. This processing can be executed in real time to enable the positive growth cycle to be driven more quickly.

Next, there will be described a second embodiment of the present invention.

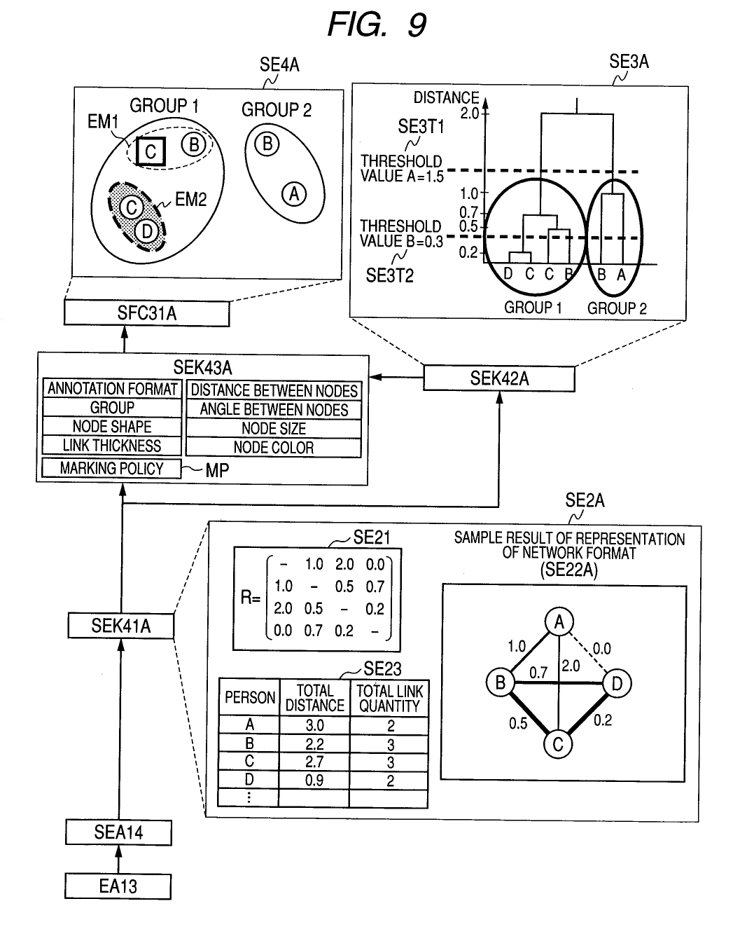

FIG. 9 shows a sample result of the representation of the calculation of a relationship distance between any persons (SE2A) and another sample result of the representation of an organization structure.

In the representation of the organization structure (SE4) shown in FIG. 8, only a relationship between a person and a group is shown. In this second embodiment, however, a person or organization that takes a characteristic behavior is marked and displayed. And in order to realize such a display concretely, a feature table is prepared for each person (SE23) in the calculation of a distance between any persons/the feature of each person (SEK41A) to administrate the total amount of each person distance and the total amount of number of links. For example, marking is made for a person having the largest total sum among those calculation results. In the example shown in FIG. 9, the person C is marked as a person having the largest sum. In other words, in the example shown in FIG. 9, a relationship between the person C and another person is stronger than the relationship between another person and still another person.

Here, marking can also be made simply for the highest level person of total amount distance or for the highest level person of total number of links. And marking can also be made for the lowest level person of total amount distance or the lowest level person of total number of links. The marking method is set in the procedure of the organization structure parameter (SEK43A) so as to change the color, size, and shape of each node to be marked. Those results are denoted in the process of organization structure representation (SE4A) through the process of the representation of organization structure (SFC31A). In the example shown in FIG. 9, the node C is marked (displayed as a square node) (EM1). Marking like this makes it possible to identify each person characteristic in behavior in each organization (e.g., a person playing the role of a hub in the subject organization) on the display screen image. In this case, the user (US) or administrator is required to set the marking objects and the marking method in the column of marking policy (MP) provided in the process of organization structure parameter (SE43K) beforehand.

In the above example, only specific persons are marked. Next, however, there will be described an example for marking a group (a set of persons) that makes characteristic interactions. In the process of display of group result (SE3A) for grouping (SEK42A), a threshold value for grouping (SE3T1), as well as a threshold value (SE3T2) for deciding a relationship distance level are set. In the example shown in FIG. 9, the SE3T2 value is set at 0.3 and a set of persons under this threshold value becomes (the set of persons C and D). The relationship between the persons C and D is stronger than the relationship denoted by the threshold value (SE3T2). The user (US)/administrator specifies characteristic marking (e.g., enclosed hatching display) for those persons in the process of representation of organization structure (SFC31A), thereby the set of persons C and D is marked (EM2). In such a way, not only specific persons, but also persons and groups playing active roles respectively comes to be marked.

This marking may also be made by displaying any symbols as nodes instead of changing the color or shape of those nodes. The symbol mentioned here may be any of a color, texture, figure, sign or a combination of those.

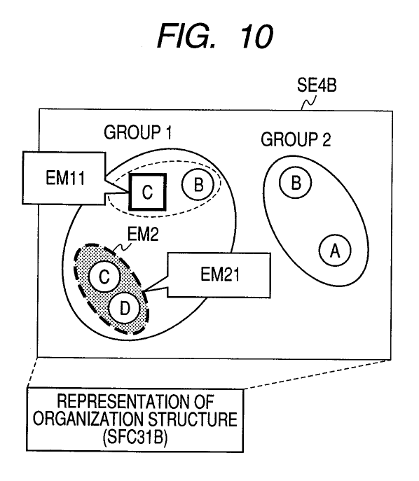

Furthermore, instead of changing the color and shape of nodes, it is also possible to add an annotation (text image) to each characteristic person and each set of persons as shown in the sample result of representation of the organization structure (SE4B) shown in FIG. 10. In FIG. 10, an annotation of hub organization (EM11) is displayed for the person C. This annotation includes the information denoting the relationship between the person C and another person. On the other hand, an annotation of active interaction (EM21) is added to the set of persons C and D. This annotation includes the information denoting the relationship between the persons C and D. Therefore, the use of annotations in such a way makes it possible to display each characteristic person or group in each organization more remarkably than others.

Next, there will be described a third embodiment of the present invention. Presentation of daily activity state to a user (US) is effective to promote his/her motivation to his/her business work. And the following feedback effects applied to the user will also promote such his/her motivation; 1) communization of problem consciousness by visualizing the current state of the subject business work and 2) incentive advancement for wearing sensor nodes. In this third embodiment, there will be described a process for feeding back an analysis result found by an application server (AS) to a user (US) through web sites and e-mails.

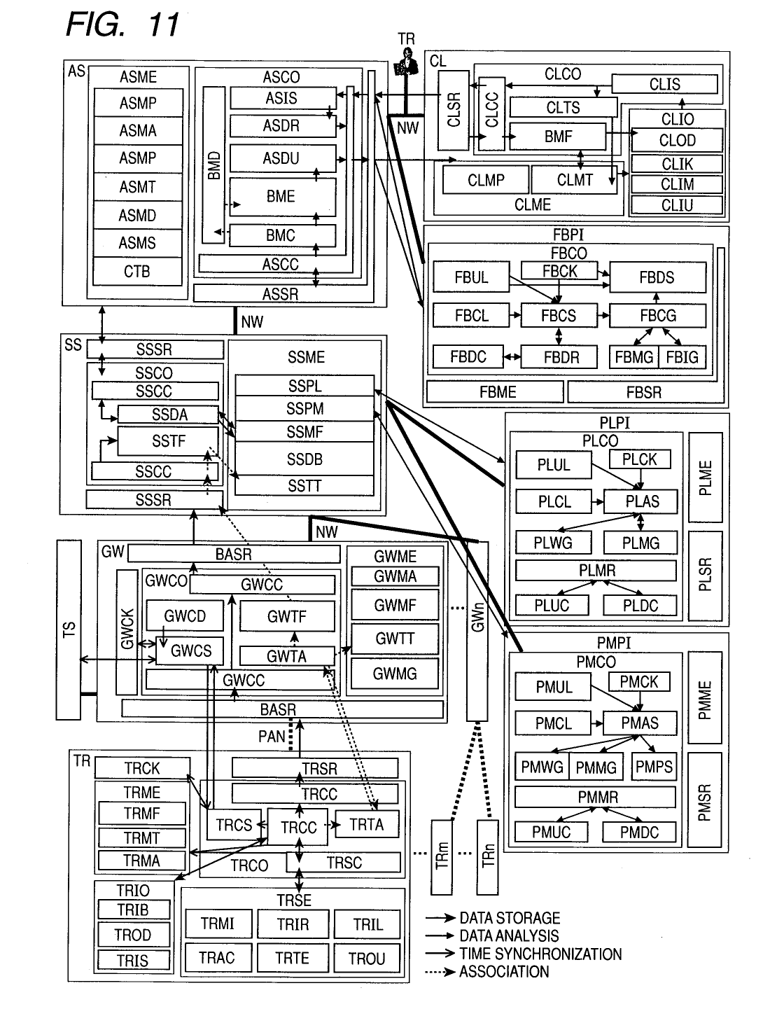

FIG. 11 illustrates a whole system employed for processings from sensor data acquisition to feedback to the user. Hereinafter, only the processings newly added to FIG. 2 will be described.

The feedback unit (EBPI) presents an analysis result found by the application server (AS) to the user through an e-mail or networks. The feedback unit (FBPI) consists of a control unit (FBCO), a recording unit (FBME), and a radio sender/receiver unit (FBSR). Hereunder, at first, there will be described each processing to be executed in the control unit (FBCO).

The watch (FBCK) holds the current time. The user list (FBUL) includes each feedback object user name and a content number denoting the object feedback type. The contents list (FBCL) stores processes for specifying a feedback method such as presentation through e-mails and web sites, data acquisition, content generation, and content sending to each user. The process of content selection (FBCS) selects a feedback type according to the specification from the user list (FBUL) and the content list (FBCL). The process of read data (FBDR) requests the application server (AS) for necessary data to create a content through the wireless/wired sender/receiver unit wireless/wired sender/receiver unit (FBSR) and obtains the result through the wireless/wired sender/receiver unit (FBSR). The process of data check (FBDC) checks presence of error data and data missing in the user name, date, format, etc. read in the process of read data (FBDR). The process of content generation (FBCG) generates a content from data according to the content creation procedure obtained in the process of content selection (FBCS). The process of sentence generation (FBMG) generates a sentence necessary for feedback from data obtained in the process of read data (FBDR) in the process of content generation (FBCG). The process of image generation (FBIG) generates an image necessary for feedback from data obtained in the process of read data (FBDR) in the process of content generation (FBCG). The process of data sender (FBDS) sends data (output result) of the content generation (FBCG) with use of a presentation method requested by the user (US). The recording unit (FBME) records data required in the processings executed by the control unit (FBCO). The wireless/wired sender/receiver unit (FBSR) includes functions for the communication with the application server, as well as functions for the wired or wireless connections to a cellular phone network and the Internet.

The PC operation log input unit (PLPI) sends the operation history of the user's personal computer to the sensor-net server (SS). The PC operation log input unit (PLPI) consists of a control unit (PLCO), a recording unit (PLME), and a wireless/wired sender/receiver unit (PLSR). Hereinafter, there will be described each processing executed in the control unit (PLCO).

The watch (PLCK) holds the current time. The user list (PLUL) records each user name for which a PC operation history is to be obtained, as well as a method for obtaining a PC log. The content list (PLCL) stores procedures for presenting each content of plural methods for obtaining the PC operation history through web sites and e-mails. The selection of acquisition method (PLAS) selects a method for obtaining a PC log according to the specification set in the user list (PLUL) and in the content list (PLCL). The web generation (PLWG) describes a sentence and image required to obtain a PC log through web sites. The process of mail generation (PLMG) describes a sentence required to obtain a PC log with use e-mails. The process of records registration (PLMRG) checks a PC log sent from the user and sends the PC log to the sensor-net server (SS) through the wireless/wired sender/receiver unit (PLSR). The process of user check (PLUC) checks whether or not obtained data is owned by the user. The date check (PLDC) checks whether or not obtained data has a subject date. The recording unit (PLME) records data required for the processings executed by the control unit (PLCO). The PC operation log input unit (PLPI) has functions required for wired or wireless communications with the sensor-net server (SS), as well as functions required for the wired or wireless connections to cellular phone networks and Internet networks.

The performance input unit (PMPI) obtains user performance in the form of questionnaire with respect to the user's subjective assignment and sends the performance to the sensor-net server (SS). The performance input unit (PMPI) consists of a control unit (PMCO), a recording unit (PMME), and a wireless/wired sender/receiver unit (PLSR). Hereunder, there will be described each processing executed in the control unit (PMCO). The user list (PMUL) describes each user name for which user performance is to be obtained, as well as its obtaining method. The watch (PMCK) holds the current time. The performance list (PMCL) describes plural methods for measuring each user's subjective assessment, a presentation method of a questionnaire about each content, a method for sending the result to the application server (AS). The selection of acquisition method (PMAS) selects a method for acquiring performance according to a specification set in the user list (PMUL) and in the performance list (PMCL). The process of web generation (PMWG) describes a sentence and image required to acquire performance through networks. The mail generation (PMMG) describes a sentence required to acquire performance through an e-mail. The process of presentation (PMPS) presents a questionnaire created in the process of selection of acquisition method (PMAS) to the user through the wireless/wired sender/receiver unit (PLSR). The process of records registration (PMMR) checks the performance sent from the user and sends the performance to the sensor-net server (SS) through the wireless/wired sender/receiver unit (PLSR). The process of user check (PMUC) checks whether or not obtained data is owned by the user. The process of date check (PMDC) checks whether or not obtained data has the subject date. The process of recording unit (PMME) records data required for the processings executed in the control unit (PMCO). The wireless/wired sender/receiver unit (PLSR) has functions required for the communications with the sensor-net server (SS), as well as functions required for wireless or wired connections to the cellular phone networks and Internet networks.

The sensor-net server (SS) stores sensor data received from each terminal (TR) through a gateway (GW) in the sensing database (SSDB) provided in the recording unit (SSME). The recording unit (SSME) also includes a PC log database (SSPL) and a performance database (SSPM). The PC log database (SSPL) stores data received from the PC operation log input unit (PLPI) while the performance database (SSPM) stores data received from the performance input unit (PMPI).

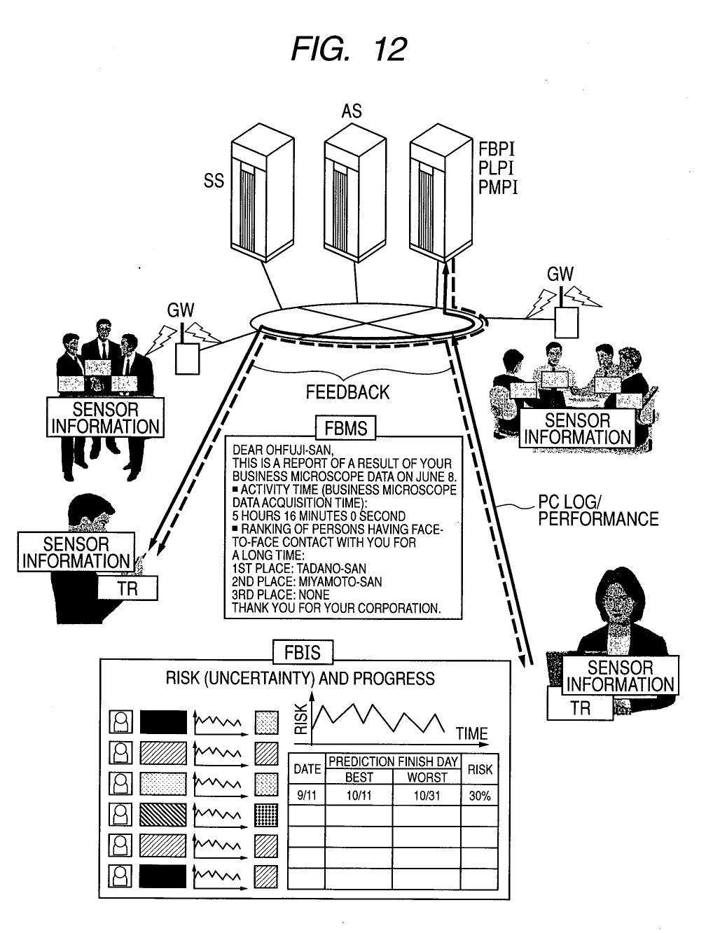

FIG. 12 shows an image for using the feedback realized as shown in FIG. 11. Hereunder, there will be described a series of feedback processings. At first, sensor information acquired from a user's terminal (TR) is sent to the sensor-net server (SS) through a gateway (GW). The user's subjective assessment (performance) is also sent to the sensor-net server (SS) through the performance input unit (PMPI) and the PC operation history is sent to the sensor-net server (SS) through the PC operation log input unit (PLPI) respectively. Those data are then used for an analysis executed in the application server (AS). And the feedback unit (FBPI) makes a feedback to the user according to the analysis result of the application server (AS). There are plural feedback methods; feedback by using e-mails (FBMS), feedback by using both Web site and screen-saver (FBIS), and feedback executed as distribution to the object terminal (TR). The user checks the feedback contents through his/her portable phone and through a client (CR).

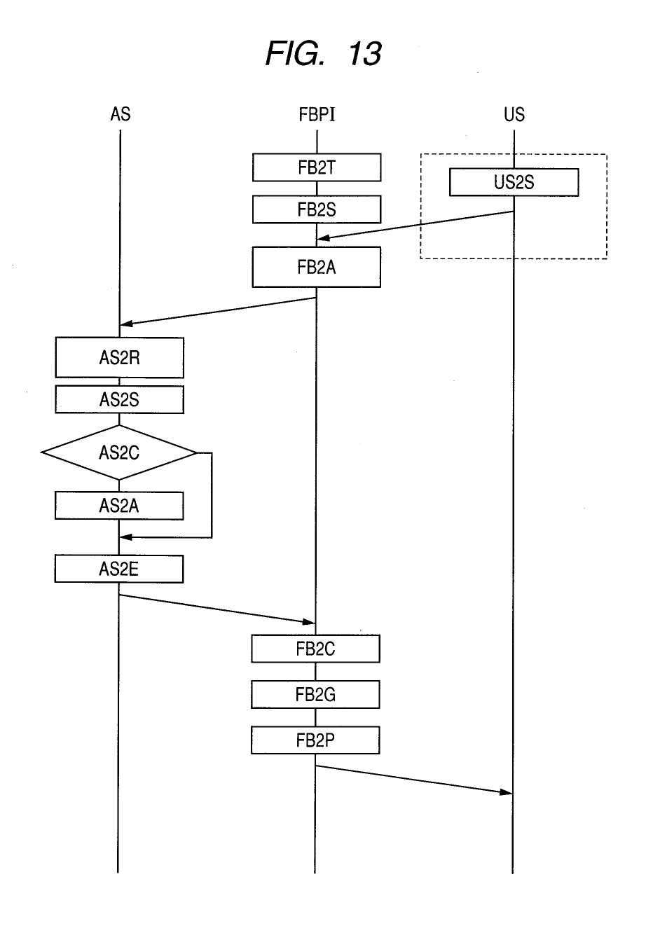

FIG. 13 shows a sequence chart for the processings of the feedback unit (FBPI). In these processings, the application server (AS) and the feedback unit (FBPI) distribute feedback contents to the object client user (US) with use of an e-mail at a specific time.

In the feedback unit (FBPI), the startup timer (FB2T) starts a processing at a preset starting time.

Then, the feedback unit (FBPI) executes the processing of item selection (FB2S) in the process of content selection (FBCS). Concretely, the feedback unit (FBPI) selects a feedback object user from the user list (FBUL) and selects the user desired feedback method from the contents list (FBCL), then outputs the method to the object user. It is premised here that the feedback content and presentation method are decided by the user beforehand and the content is registered as a process procedure in the content list (FBUL).

Then, the feedback unit (FBPI) executes the processing of sender of data acquisition request (FB2A) in the process of read data (FBDR). Concretely, the feedback unit (FBPI) requests the application server (AS) to obtain the user name acquired in the process of item selection (FB2S) and sensor data necessary to create object contents.

Upon receiving the request, the application server (AS) receives the user name and desired data name from the wireless/wired sender/receiver unit (FBSR) in the process of receiver of data acquisition request (AS2R) through the sending/receiving unit (ASSR).

After this, in the process of data search (AS2S), the application server (AS) searches requested data according to the search keys that are user name and data name received in the process of receiver of data acquisition request (AS2R) and acquires the data.

In the process of presence of data check (AS2C), the application server (AS) checks output data of the data search (AS2S). If any data missing is found in the check, the application server (AS) analyzes the data missing portion (AS2A). If no data missing is found in the check, the application server (AS) goes to the process of data sender (AS2E).

In the process of analysis (AS2A), the application server (AS) specifies the user name and the data missing time, then analyzes the missing data portion.

In the process of data sender (AS2E), the application server (AS) sends obtained data to the wireless/wired sender/receiver unit (FBSR) of the feedback unit (FB).

In the process of data receiver (FB2R), the application server (AS) receives desired data from the sending/receiving unit (ASSR) through the wireless/wired sender/receiver unit (FBSR).

The process of data authentication (FB2C) is executed by the feedback unit (FBPI) in the data check (FBDC) process. In this process, the feedback unit (FBPI) checks whether or not any error is included in the sensor data acquired by the application server (AS).

The feedback unit (FBPI) then executes the processing of screen and sentence generation (FB2G) in the process of content generation (FBCG). The processing creates an object content according to the content generation procedure selected in the item selection (FB2S) in the process of content selection (FBCS); if the object content is a mail, the mail is created in the process of the mail generation (FBMG) and if the object content is an image, the image is created by the process of image generation (FBIG).

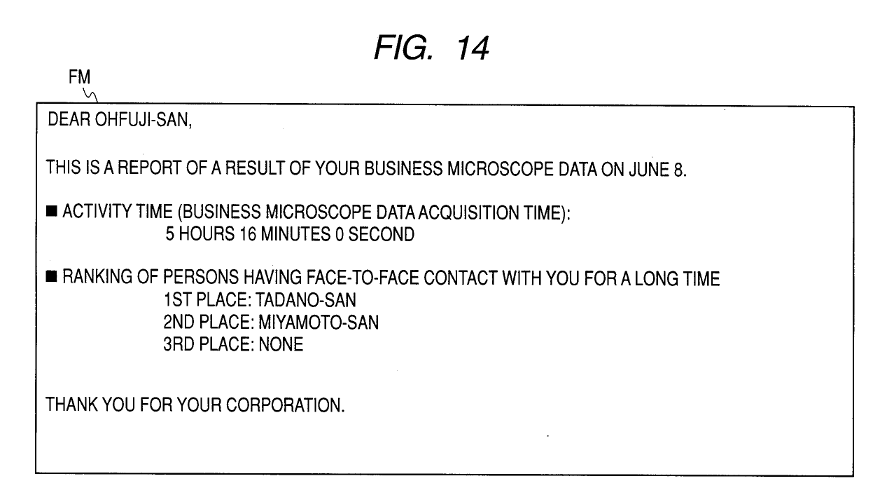

FIG. 14 shows an example of a mail created in the process of mail generation (FBMG). The feedback mail (FM) shown in FIG. 14 shows daily activity with letters. The mail (FM) displays a ranking list of the object persons having longer activities and face-to-face times obtained from the sensor data collected on the subject analysis day. Each feedback content is created in such a way by using the data and the content list (FBCL) acquired from the application server (AS). The presentation (FB2P) is a processing executed in the process of data sender (FBDS). The user name and the content presentation method specified in the item selection (FB2S) are used to present the object content to the user. The presentation method is described in the user list (FBUL); any of presentation by mail, presentation through a web site, and presentation through the screen saver can be selected. Furthermore, a terminal (TR) can be specified as the destination of the feedback result. In this case, the destination becomes the sensor-net server (SS). The user can request a feedback any time and acquire the feedback receiving timing; there is no need to preset the timing. In this case, as shown in FIG. 13, the user executes the process of item selection (US2S) in the user client (US). In the process of item selection (US2S), the user selects the user name and the feedback content, and the content presentation method. The user then sends the results to the feedback unit (FBPI), thereby the feedback processing is executed.

This completes the description of the feedback processing for presenting the daily state to the user. This feedback processing enables the user to understand/reflect his/her current state and to think and act more properly therefrom on. And as described above, the presentation to the user should preferably be made so as to be able to meet the user's taste and vary the analysis content and presentation method as needed.

Next, there will be described a fourth embodiment of the present invention.

In the third embodiment described above, descriptions have been made for feedback methods and feedback examples by using e-mails. In this fourth embodiment, feedback examples will be described with use of images as another feedback contents.

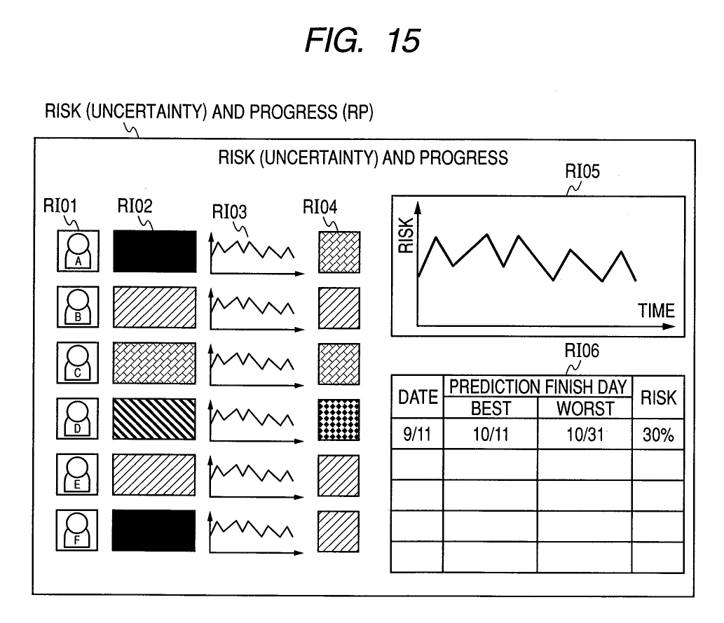

FIG. 15 shows a feedback example with use of an image. In FIG. 15 are shown risk assessment, an element of uncertainty, and progress assessment (PR) in a business work by a group. A risk means a digitized concept of whether or not a task is finished as scheduled. This risk is shown to the user, thereby prompting the user to review his/her activity. An image (RI01) is specific to identify each user. The image should preferably include a user's picture such as a face photo.

A lucky color (RI02) is a color assigned to the feature of each user, which is considered to be most effective to obtain a favorable result in a business work among the features of the user's actions. As features, the following can be employed; conversation time, the number of persons in conversation, walking time, PC operation time, walking frequency, utterance, conversation partner, activity level, temperature, infrared sensor's sensing frequency, spectrum value after furrier conversion of sensor signals, zero-cross data of a sensor signal, etc.

In FIG. 15, instead of colors, hatching is employed for displaying features. Hereunder, how to select a lucky color will be described. At first, the process of personal feature extraction (EA13) is executed for each user to extract the user's feature. At this time, features having a date on which the performance is registered respectively are used. No feature for which no date is registered is used. In this case, it is premised that a color is assigned to each feature beforehand. For example, red is decided to be used for feature 1 and blue is decided to be used for feature 2.

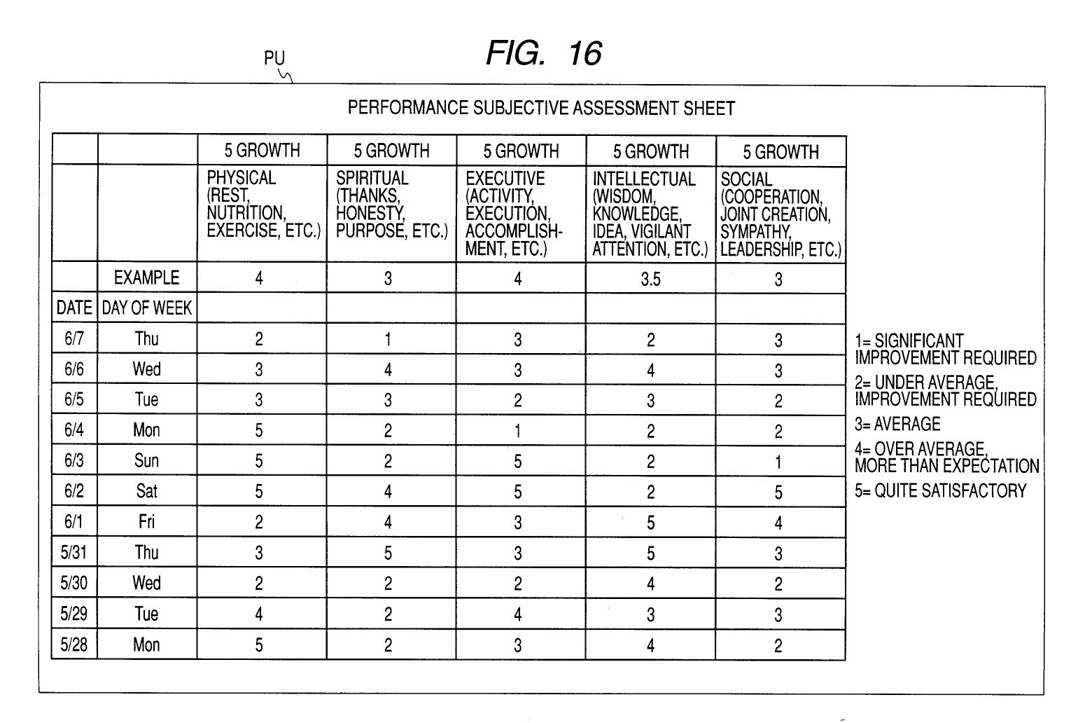

Furthermore, a questionnaire as shown in FIG. 16 is made and the result is inputted to the performance input unit (PMPI). The performance subjectively-based questionnaire (PU) shown in the example in FIG. 16 makes assessment of a user's action from five viewpoints. The user makes 5-grade assessment for each item (1 is the lowest and 5 is the highest). Then, the user selects one item from among those in the questionnaire and makes an analysis with use of the feature of the selected item.

Next, there will be described an analysis method. For example, at first, one feature is extracted. The feature denotes a high value if the assessment result in a user's questionnaire is high and a low value if the assessment result in a user's questionnaire is low. The feature color is then specified as the user's lucky color (RI02). This value may also be found with use of the multivariate analysis, which is a known analysis method such as discrimination analysis, regression analysis, etc.

An action graph (RI03) denotes a daily personal state. This graph is not used for performance. The graph is used here for an analysis employed for finding a lucky color (RI02) and for an analysis that uses a feature obtained from the latest time sensor data. Then, the feature is plotted at the sensor data acquired point of time.

As a result, a low value in the graph comes to denote that the feature is low. It is thus understood that the action is not favorable. At this time, a preset feature color is selected for the highest feature value and the color is displayed on the RI04 as the current color.

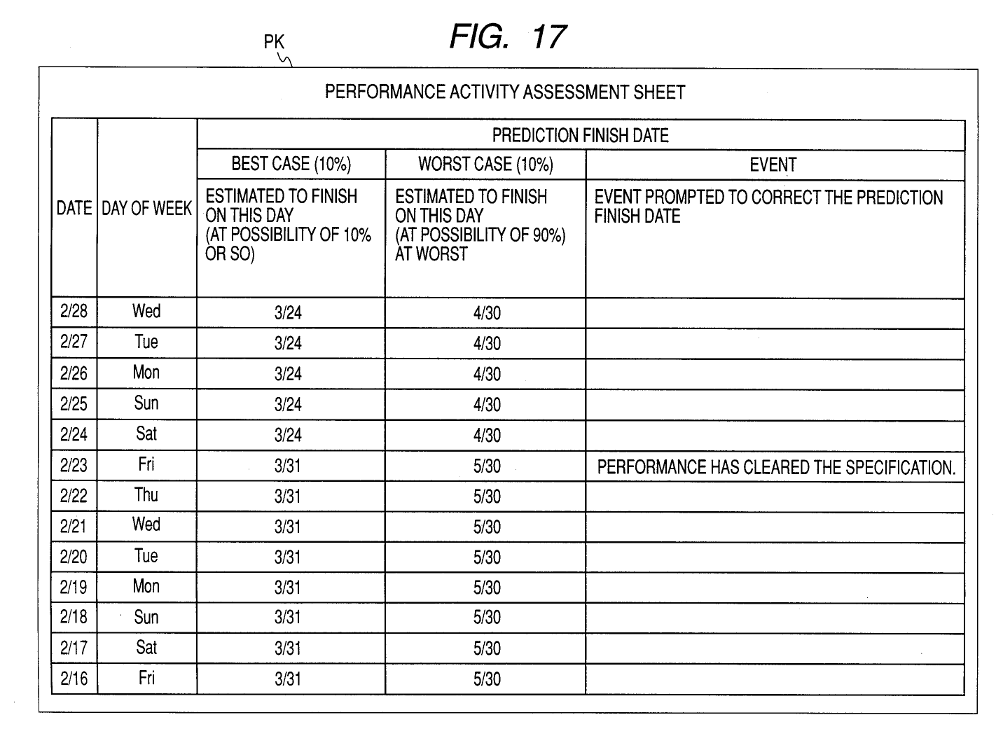

The prediction finish time table (RI06) displays the result of the questionnaire shown in FIG. 17. This questionnaire is referred to as a performance activity questionnaire (PK). The user is requested to answer to each item by inputting necessary data to the daily questionnaire just like the performance subjectively-based questionnaire (PU). The result of the performance activity questionnaire (PK) is inputted to the performance input unit (PMPI). The finish possibility is found from the current date, as well as the best and worst dates. The result is displayed as a risk. For example, it is premised that the farther the worst date and the best date are separated from each other, the more the subject becomes vague, thereby the risk is decided to be high. Consequently, the coefficients in that section are multiplied by each other and the result is assumed as a risk value.

The prediction finish table (RI06) denotes the current state while a risk graph (RI05) displays risk values in the past.

In such a way, the user checks a graph denoting both risk (uncertainty) and progress, thereby reviewing his/her own actions. Furthermore, because a color is defined for each feature, the user's own lucky color can be decided from both performance and feature. The user can thus decide easily what action should be taken next according to the feedback result obtained with use of this lucky color.

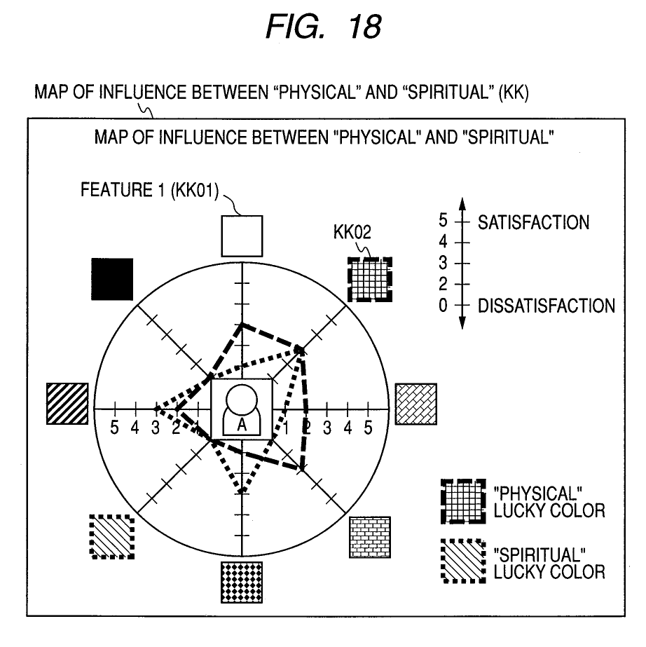

FIG. 18 shows another sample result of representation of a feedback content. In the example shown in FIG. 15, one item is fed back to each user. In FIG. 18, however, plural items can be displayed simultaneously as feedback items. FIG. 18 is a radar chart denoting a degree of each of physical and spiritual satisfaction.

In order to create the radar chart shown in FIG. 18, it is required to decide a color for each feature. In FIG. 18, the center of the radar chart is decided as the user and color objects denoting features respectively are plotted on the concentric circle. Then, the center and each of the color objects is connected with a line and the values are plotted so that the values become smaller towards the center. After this, plotted points are connected to each other.

After that, the “physical” lucky color (KK02) is obtained by using the method that has obtained the lucky color shown in FIG. 15. Then, in order to illustrate plural degrees of satisfaction, distinction is required among lucky colors. For example, the frame around each color object is used. The “physical” lucky color (KK02) corresponds to the feature 2 and the color object of the feature 2 is surrounded by a dashed line. And just like the action graph (RI03), the feature is found and plotted with respect to the daily state. Each feature is decided in five grades and the current state of the user is plotted. In the five-grade assessment, 1 denotes dissatisfaction and 5 denotes satisfaction. Each feature displays one of the five-grade values.

In order to display plural lucky colors in such a way, it is required to make discrimination among those lucky colors. In the example shown in FIG. 18, the frame of each color object is used to identify each of those lucky colors. However, different icons and letters can also be used for such identification.

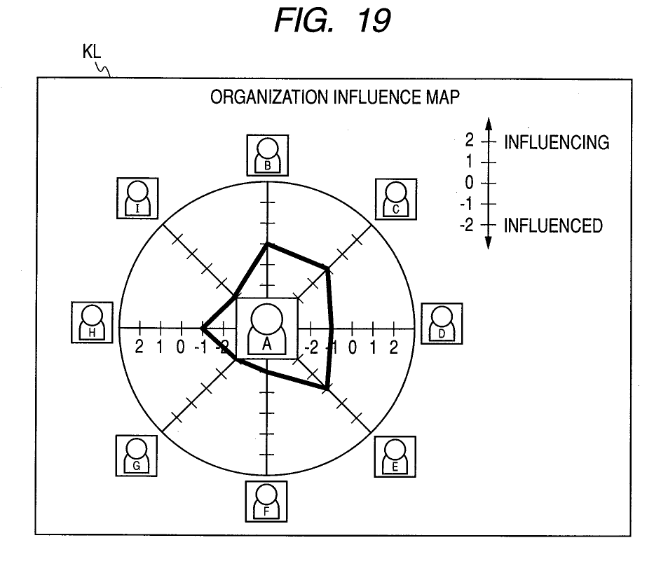

Finally, FIG. 19 shows a feedback example with an organization influence map (KL). This map shows who affects whom and who is affected by whom in the subject organization. In the example shown in FIG. 19, the center of the radar chart is defined as the user (A) and other members (B to I) are plotted on the concentric circle, thereby denoting a degree of influence between the user and each of other members. Then, the user (A) is connected to each of other members with a line and the center of the line is defined as 0. A positive value denotes an influence exerting on any one and a negative value denotes an influence exerted from any one. Those values are plotted and plotted points are connected to each other with a line.

This degree of influence is found as follows. At first, a correlation coefficient (shown in FIG. 1) of each member's personal feature (EA12) is found and a correlation matrix is created so that the number of members is equalized with the number of nodes disposed on the vertical and horizontal axes of the matrix. Because the correlation matrix becomes a symmetrical matrix, each correlation value between two persons takes the same value. Then, a unique coefficient is found for each user and the correlation value between two persons is multiplied by the coefficient value to find the influence between those persons. For example, if it is premised that the longer the activity of a user is, the more the user influences strongly on another user, each user acquiring time is found, then it is defined as the unique coefficient of the user. Although this coefficient value can be decided freely, any one of coefficients is required here to find an influence from a correlation matrix. Then, each correlation value between two persons is multiplied by such a coefficient, thereby clarifying an influence between those persons. A degree of influence is found from a comparison between the influence values of those persons (e.g., a difference between influence values). A degree of influence between users may also be found by a multivariate analysis that is such a known analysis method as discrimination analysis or depression analysis.

Because the correlation matrix of acceleration movement is used in such a way, the state of the organization can be visualized as a degree of influence.

Furthermore, instead of such a correlation coefficient (shown in FIG. 1) of each member's personal feature (EA12), it is also possible to use a correlation coefficient between the performance activity questionnaire of each of the members (PK) and such a subjective assessment value as that of the performance subjectively-based questionnaire (PU), etc.

This completes the description of an example for executing feedback processings through visualization with images. And one of the merits for using images for feedback processings as described above is to enable the user to acquire a mass of information at a glance due to those images. For example, by acquiring a specific color (lucky color) from performance and sensor data, the user can know easily what action he/she should take next. Furthermore, by finding a coefficient for visualizing the state of the subject organization, which is a degree of influence, from an acceleration movement feature, the dependency among the works in the organization can be visualized.

In the third and fourth embodiments described above, each motion feature is related to a color. However, any of the color, figure, texture, sign and a combination of those may be related to a motion feature. In this case, in FIGS. 12, 15, and 18, a symbol related to each feature is displayed instead of a color.

What is claimed is:

1. A sensor-net system, comprising:
a plurality of terminals; and
a processor for processing data received from the plurality of terminals,
wherein each of the plurality of terminals includes a sensor for sensing a physical amount and a data sending unit for sending data denoting the physical amount sensed by the sensor, and
wherein the processor calculates a value denoting a relationship between a first terminal wearing person and a second terminal wearing person according to the data received from the first terminal and the data received from the second terminal.

2. The sensor-net system according to claim 1,
wherein the value denoting the relationship between the first and second persons is a value of cross-correlation between physical amounts sensed by the sensors of the first and second terminals.

3. The sensor-net system according to claim 2,
wherein the sensor senses acceleration as the physical amount.

4. The sensor-net system according to claim 3,
wherein the processor calculates a value of cross-correlation between frequency distribution of the acceleration sensed by the first terminal sensor and frequency distribution of the acceleration sensed by the second terminal sensor as a value denoting a relationship between the first and second persons.

5. The sensor-net system according to claim 4,
wherein the processor executes processes of:
counting the number of pairs, each pair consisting of two consecutive sensing points of time, one at which the sensor senses an acceleration value and the other at which the sensor senses another acceleration value and the two sensed acceleration values are reversed in positive and negative state between those consecutive sensing points of time;
counting the number of times the acceleration value becomes zero according to the number of counted pairs; and
calculating frequency distribution of acceleration sensed by the sensor according to the obtained count assumed as an acceleration frequency.

6. The sensor-net system according to claim 2,
wherein the sensor senses a voice as the physical amount.

7. The sensor-net system according to claim 1,
wherein each of the plurality of terminals further includes a radio signal sending unit for sending a radio signal including an identifier of each of the terminals,
wherein the sensor of each of the terminals senses the radio signal received from a different one of the plurality of terminals,
wherein the data received from each of the terminals includes the identifier of the terminal included in the radio signal sensed by each of the terminals and information denoting the number of sensing times of the radio signal received from the terminal identified by the identifier, and
wherein the processor calculates a value denoting a relationship between the first and second persons so that it is denoted that the more frequently the first terminal senses the radio signal received from the second terminal, the stronger the relationship between the first and second persons becomes.

8. The sensor-net system according to claim 1,
wherein the system further includes an image display apparatus for displaying each of the persons,
wherein the processor calculates a value denoting a relationship between a third terminal wearing person and a fourth terminal wearing person according to the data received from the third and fourth terminals, and
wherein the image display apparatus displays an image for each of the persons so that a distance between the first person's image and the second person's image may differ from a distance between the third person's image and the fourth person's image if the value denoting the relationship between the first and second persons differs from the value denoting the relationship between the third and fourth persons.

9. The sensor-net system according to claim 8,
wherein the image display apparatus displays an image for each of the persons so that a distance between the first person's image and the second person's image becomes shorter than a distance between the third person's image and the fourth person's image if the value denoting the relationship between the first and second persons denotes a stronger relationship than the value denoting the relationship between the third and fourth persons.

10. The sensor-net system according to claim 1,
wherein the system further includes an image display apparatus for displaying an image for each of the persons,
wherein the processor further calculates a value denoting a relationship between the third terminal wearing person and the fourth terminal wearing person according to the data received from the third and fourth terminals, and
wherein the image display apparatus displays:
a first line for coupling the first person's image with the second person's image;
a second line for coupling the second person's image with the fourth person's image; and
the first and second lines so that thickness may differ between the first and second lines if the relationship value between the first and second persons differs from the relationship value between the third and fourth persons.

11. The sensor-net system according to claim 10,
wherein the image display apparatus displays the first and second lines so that the first line becomes thicker than the second line if the value denoting the relationship between the first and second persons denotes a stronger relationship than the value denoting the relationship between the third and fourth persons.

12. A method for controlling a sensor-net system that includes a plurality of terminals and a processor for processing data received from the plurality of terminals,
wherein each of the terminals includes a sensor and a data sending unit,
wherein the method includes the steps of:
enabling the sensor of each of the terminals to sense a physical amount;
enabling the data sending unit of each of the terminals to send data denoting the physical amount sensed by the sensor; and
enabling the processor to calculate a value denoting a relationship between the first terminal wearing person and the second terminal wearing person according to the data received from the first and second terminals.

13. The method according to claim 12,
wherein each of the terminals includes a radio signal sending unit for sending a radio signal including an identifier of each of the terminals,
wherein the sensor of each of the terminals senses the radio signal received from different one of the terminals;
wherein the data received from each of the terminals includes the identifier of the terminal included in the radio signal sensed by each of the terminals and information denoting the number of sensing times of the radio signal received from the terminal identified by the identifier, and
wherein the method further includes a step of:
enabling the processor to calculate the value denoting a relationship between the first and second persons so as to denote that the more frequently the first terminal senses the radio signal received from the second terminal, the more stronger the relationship between the first and second relationship becomes.

14. The method according to claim 12,
wherein the sensor-net system further includes an image display apparatus for displaying an image for each of the persons, and
wherein the method further includes the steps of:
enabling the processor to calculate a value denoting a relationship between the third terminal wearing person and the fourth terminal wearing person according to the data received from the third and fourth terminals; and
enabling the image display apparatus to display an image for each of the persons so that a distance between images of the first and second persons differs from a distance between images of the third and fourth persons if the value denoting the relationship between the first and second persons differs from the value denoting the relationship between the third and fourth persons.

15. The method according to claim 12,
wherein the sensor-net system further includes an image display apparatus for displaying an image for each of the persons,
wherein the method further includes the steps of:
enabling the processor to calculate a value denoting the relationship between the third terminal wearing person and the fourth terminal wearing person according to the data received from the third and fourth terminals;
enabling the image display apparatus to display a first line for coupling the first person's image with the second person's image; and
enabling the display apparatus to display a second line for coupling the third person's image with the fourth person's image, and
wherein the image display apparatus displays the first and second lines so that thickness may differ between the first and second lines if the value denoting the relationship between the first and second persons differs from the value denoting the value denoting the relationship between the third and fourth persons.

16. The sensor-net system according to claim 8,
wherein the image display apparatus displays an image of a first group including the first and second persons and another image of a second group including the third and fourth persons if the value of the relationship between the first and second persons denotes a stronger relationship than a predetermined threshold value while the value of the relationship between the third and fourth persons does not denote a stronger relationship than that denoted by the predetermined threshold value;
wherein the image of the first group includes a symbol that is not included in the image of the second group; and
wherein the symbol is at least either of a color, a texture, a figure, or a sign, or a combination of any two of those items, and a character image of a relationship between the first and second persons.

17. The sensor-net system according to claim 8,
wherein the processor executes the processes of:
calculating a strength of a relationship between the first person and a different person other than the first person according to a value of a relationship between the first person and the different person other than the first person;
calculating a strength of a relationship between the second person and a different person other than the second person according to a value of a relationship between the second person and the different person other than the second person;
wherein the first person's image includes a symbol that is not included in the second person's image if the relationship between the first person and the different person other than the first person is stronger than the relationship between the second person and the different person other than the second person, and
wherein the symbol is at least either of a color, a texture, a figure, or a sign, or a combination of any two or more of those items, and a character image of a relationship between the first person and the different person other than the first person.

18. The sensor-net system according to claim 1,
wherein the system further includes an image display apparatus for displaying an image for each of the persons,
wherein processor further executes the processes of:
calculating a feature of an action of each of the persons according to the data received from each of the terminals;
classifying the action of each of the persons according to the calculated action feature;
notifying each of the persons of information denoting the feature of each of the persons with respect to the classified action;
acquiring information for specifying at least one of the feature to be notified to each of the persons, a timing of the notification, and a method of the notification;
notifying each of the persons of information denoting the feature specified by the acquired information if the acquired information specifies the feature to be notified to each of the persons;
executing the notification at a timing specified by the acquired information if the acquired information specifies a timing of the notification; and
executing the notification according to a method specified by the acquired information if the acquired information specifies a method of the notification, and
wherein the notification of the information denoting the feature is executed by any of a method for sending an e-mail including the information denoting the feature or a method for displaying the information denoting the feature on an image display apparatus included in the sensor-net system.

19. The sensor-net system according to claim 1,
wherein the system further includes an image display apparatus for displaying an image for each of the persons,
wherein the processor further executes the processes of:
calculating a feature of an action of each of the persons according to the data received from each of the terminals; and
classifying the action of each of the persons according to the calculated feature,
wherein the image display apparatus displays a symbol corresponding to the feature of the classified action of each of the persons,
wherein the processor further executes the processes of:
acquiring information denoting performance of each of the persons; and
calculating correlation between the feature of the classified action of each of the persons and the acquired performance of each of the persons,
wherein the image display apparatus further displays the symbol corresponding to the feature of the classified action of each of the persons, having a peak value of the calculated correlation, and
wherein the symbol includes a color, a texture, a figure, a sign, or a combination of any two of those items.

20. The sensor-net system according to claim 1,
wherein the system further includes an image display apparatus for displaying an image for each of the persons,
wherein the processor further executes the processes of:
calculating a feature of an action of each of the persons according to the data received from each of the terminals;
calculating correlation between the calculated feature of the action of each of the persons and another; and
calculating a degree of influence between each of the persons and another by multiplying the calculated correlation value by a predetermined coefficient, and
wherein the image display apparatus displays the calculated degree of influence.
